(19) United States
(12) Patent Application Publication
(10) Pub. No.: US 2015/0116208 A1
(43) Pub. Date: Apr. 30, 2015

(54) TERMINAL APPARATUS, INFORMATION PROCESSING APPARATUS, AND DISPLAY CONTROL METHOD

(71) Applicant: FUJITSU LIMITED, Kawasaki-shi (JP)

(72) Inventor: Tetsuo Akitomi, Shinagawa (JP)

(21) Appl. No.: 14/519,800

(22) Filed: Oct. 21, 2014

(30) Foreign Application Priority Data
Oct. 24, 2013 (JP) 2013-221163

(51) Int. Cl. G06F 3/023

(52) U.S. Cl. CPC G06F 3/0237
USPC 345/156

(57) ABSTRACT

A control unit displays, on a display device, a screen according to screen data received from an information processing apparatus. At the same time, the control unit receives a next input operation predicted by the information processing apparatus and screen data according to the predicted next input operation from the information processing apparatus and stores them in a memory. In addition, when, upon detecting a next input operation, the next input operation matches the predicted next input operation, the control unit displays, on the display device, a screen based on the screen data stored in the memory.

### CROSS-REFERENCE TO RELATED APPLICATION

This application is based upon and claims the benefit of priority of the prior Japanese Patent Application No. 2013-221163, filed on Oct. 24, 2013, the entire contents of which are incorporated herein by reference.

### FIELD

The embodiments discussed herein relate to a terminal apparatus, an information processing apparatus, and a display control method.

### BACKGROUND

There is known a desktop virtualization technique that virtualizes the desktop environment of a terminal apparatus on a server apparatus. In a system which virtualizes the desktop, information of an input operation performed on the terminal apparatus is transmitted to the server, and a process corresponding to the input operation is executed by the server. Screen data indicating the execution result is then transmitted to the terminal apparatus from the server, and a process of displaying a screen based on the data is performed by the terminal apparatus.

By virtualization of the desktop, it is possible to obtain such merits as, for example, facilitating maintenance such as adding or updating software used by a user, and allowing a user to call and use his/her own desktop environment on a terminal apparatus wherever the user is.

On the other hand, there are the following techniques for increasing the processing speed of a process corresponding to the input operation in a computer. For example, there is proposed an information processing apparatus which, when a state waiting for the operator's instruction occurs during execution of an application program, predicts a process to be performed next and performs a preceding process thereof, and resumes the process from the next step of the preceding process when the instruction from the operator matches with the prediction.

In addition, there is proposed, for example, a terminal which sends a data transfer request to a host computer upon input of a key entry identifying the next screen data, stores the next screen data transferred from the host computer and, upon receiving an input of a next screen display request, displays the stored next screen data on a display screen of the display.

Please see, for example, Japanese Laid-Open Patent Publications Nos. 1-224859 and 10-105513.

However, there is a problem in a system which virtualizes the desktop that the longer the distance of the physical transmission path between the server and the terminal apparatus becomes, the more the response delay from the input operation on the terminal apparatus to the display on the corresponding screen increases due to influence of transmission delay. For example, when a user taking a business trip overseas connects to a server located in Japan from a terminal apparatus located in Europe, a response delay of about several hundred milliseconds may occur.

### SUMMARY

According to an aspect, there is provided a terminal apparatus which transmits operation information indicating a detected input operation to an information processing apparatus, receives screen data according to the input operation from the information processing apparatus, and displays, on a display device, a screen based on the received screen data, the terminal apparatus including a memory configured to temporarily store screen data, and a processor configured to perform a procedure including: receiving screen data according to a predicted next input operation from the information processing apparatus and storing the screen data in the memory, and when, upon detecting a next input operation, the next input operation matches the predicted next input operation, displaying, on the display device, a screen based on the screen data stored in the memory.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an exemplary configuration and process of a terminal apparatus of a first embodiment;

FIG. 2 illustrates an exemplary display control system of a second embodiment;

FIG. 3 illustrates an exemplary hardware configuration of a server apparatus;

FIG. 4 illustrates a reference example of a process corresponding to an input operation when a speculative execution is not performed;

FIG. 5 illustrates an exemplary process corresponding to an input operation when a speculative execution is performed;

FIG. 6 is a block diagram illustrating an exemplary function of the server apparatus in terms of programs;

FIG. 7 illustrates exemplary functions of the server apparatus and the terminal apparatus;

FIG. 8 illustrates an exemplary area management table;

FIG. 9 illustrates an exemplary prediction management table;

FIG. 10 illustrates an exemplary executing VM management table;

FIG. 11 illustrates an exemplary predicted screen information table;

FIG. 12 illustrates an exemplary process immediately after activation of an application program;

FIG. 13 illustrates an exemplary process after an input operation on the terminal apparatus;

FIG. 14 is a flow chart illustrating an exemplary process corresponding to an input operation on a control virtual machine;

FIG. 15 is a flow chart illustrating an exemplary process corresponding to an input operation on an execution virtual machine;

FIG. 16 is a flow chart illustrating an exemplary resource copy procedure;

FIG. 17 is a flow chart illustrating an exemplary process corresponding to an input operation on the terminal apparatus;

FIG. 18 illustrates an exemplary sequence of processes corresponding to an input operation;

FIG. 19 illustrates an exemplary sequence of processes corresponding to the input operation (sequence 1);

FIG. 20 illustrates an exemplary sequence of processes corresponding to the input operation (sequence 2);

FIG. 21 illustrates an exemplary sequence of processes corresponding to the input operation (sequence 3); and

FIG. 22 illustrates an exemplary sequence of processes when prediction of the input operation is not correct.

### DESCRIPTION OF EMBODIMENTS

Several embodiments are described below with reference to the accompanying drawings, wherein like reference numerals refer to like elements throughout.

### First Embodiment

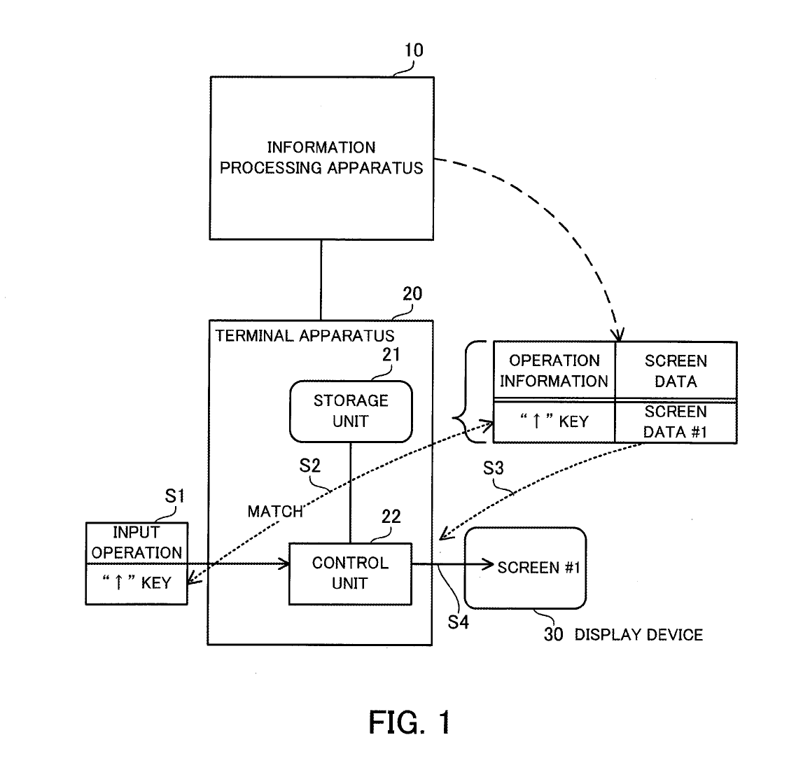

FIG. 1 illustrates an exemplary configuration and process of a terminal apparatus of a first embodiment. A terminal apparatus 20 transmits operation information indicating a detected input operation to an information processing apparatus 10, receives screen data according to the input operation from the information processing apparatus 10, and displays, on a display device 30, a screen based on the received screen data. The display device 30 may be built in the terminal apparatus 20.

The terminal apparatus 20 has a storage unit 21 and a control unit 22.

The storage unit 21 temporarily stores screen data.

The control unit 22 receives, from the information processing apparatus 10, screen data according to a next input operation predicted by the information processing apparatus 10, and stores the screen data in the storage unit 21. On this occasion, the control unit 22 receives the screen data in a state being associated with the operation information indicating the predicted next input operation, for example, and stores the screen data in the storage unit 21.

In addition, the control unit 22, upon detection of a next input operation, displays, on the display device, a screen based on the screen data stored in the storage unit 21 when the next input operation matches a next input operation predicted by the information processing apparatus 10.

For example, a screen is being displayed on the display device 30, based on the screen data received from the information processing apparatus 10. The storage unit has stored therein the operation information indicating an input operation to press the “↑” key as the operation information indicating the input operation predicted by the information processing apparatus 10, and has stored therein “screen data #1” as the screen data.

When the control unit 22 detects the input operation to press the “↑” key (step S1) in this state, the detected input operation matches the input operation indicated by the operation information stored in the storage unit 21 (step S2). Therefore, the control unit 22 reads the screen data #1 from the storage unit 21 (step S3), and displays, on the display device 30, the screen #1 based on the screen data #1 (step S4). Here, let us consider a case where, each time the terminal apparatus 20 detects an input operation, the operation information indicating the detected input operation is transmitted to the information processing apparatus 10, the screen data according to the transmitted operation information is received from the information processing apparatus 10, and a screen based on the received screen data is displayed. In this case, the longer the distance between the information processing apparatus 10 and the terminal apparatus 20 is, the larger the transmission delay between the information processing apparatus 10 and the terminal apparatus 20 becomes, taking more time for information transmission between respective apparatuses. Accordingly, it takes time to switch the screen display from when the terminal apparatus 20 detected the input operation, for at least the time corresponding to the transmission delay between the information processing apparatus 10 and the terminal apparatus 20.

In contrast, the terminal apparatus 20 of the first embodiment preliminarily receives the screen data according to the predicted next input operation from the information processing apparatus 10 before detection of a next input operation. Subsequently, upon detection of the next input operation, the terminal apparatus 20 displays, on the display device 30, a screen based on the received screen data corresponding to the predicted input operation when the predicted input operation matches the detected input operation. When the prediction is correct as described above, communication between the information processing apparatus 10 and the terminal apparatus 20 for receiving the screen data is no longer needed since the screen data indicating the screen to be displayed next has been preliminarily received and stored in the storage unit 21. Therefore, it is possible to suppress the response delay from the input operation on the terminal apparatus 20 to the display of the screen corresponding to the input operation.

### Second Embodiment

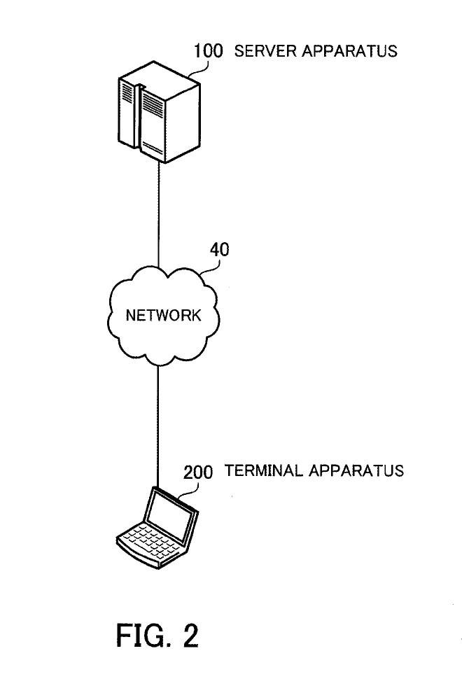

FIG. 2 illustrates an exemplary display control system of a second embodiment. The display control system of the second embodiment is a system in which a desktop environment of a terminal apparatus operated by a user is virtually implemented on a server apparatus and provided to the terminal apparatus. In the display control system of the second embodiment, the terminal apparatus behaves as though taking initiative in performing processes and displaying a screen, while the system is displaying, on the terminal apparatus, a screen based on the screen data generated in the server apparatus.

The display control system of the second embodiment has a server apparatus 100 and a terminal apparatus 200. The server apparatus 100 is an example of the information processing apparatus 10 of the first embodiment. The terminal apparatus 200 is an example of the terminal apparatus 20 of the first embodiment. The server apparatus 100 is connected to the terminal apparatus 200 via a network 40.

The server apparatus 100 is a server computer configured to virtually implement the desktop environment of the terminal apparatus 200. In addition, the server apparatus 100 may include a plurality of server apparatuses.

The server apparatus 100 receives, from the terminal apparatus 200, operation information indicating an input operation detected by the terminal apparatus 200, performs a process corresponding to the received operation information, generates screen data of a screen including the process result, and transmits the generated screen data to the terminal apparatus 200. The “process corresponding to operation information” and “generation process of screen data” mentioned here are processes realized by execution of application programs available to the user. In other words, the server apparatus 100 executes application programs available to the user in place of the terminal apparatus 200.

In addition, the server apparatus 100 predicts the user's next input operation on the terminal apparatus 200. In the following, the next input operation which has been predicted may be referred to as “predicted input operation”.

The server apparatus 100 performs the process corresponding to the predicted input operation and generates screen data of a screen including the process result. In the following, the screen data generated according to the predicted input operation may be referred to as “predicted screen data”. The server apparatus 100 transmits the predicted screen data to the terminal apparatus 200 in association with the operation information indicating the predicted input operation. In the following, the information associating the predicted screen data with the operation information indicating the predicted input operation is referred to as “predicted screen information”.

There may be a plurality of predicted input operations. In this case, the server apparatus 100 transmits predicted screen information for each of the predicted input operations.

The terminal apparatus 200 is a terminal apparatus having a display. Examples of the terminal apparatus 200 may include, in addition to a notebook computer, a mobile terminal such as a mobile phone or a tablet PC (Personal Computer), or a desktop type computer. In addition, the terminal apparatus 200 may be a dedicated terminal supporting the desktop virtualization technique such as a “thin client terminal”.

Upon detecting an input operation, the terminal apparatus 200 transmits the operation information indicating the detected input operation to the server apparatus 100 and displays, on the display, a screen based on the screen data received from the server apparatus 100 in response to the transmission. In addition, the terminal apparatus 200 preliminarily receives one or more pieces of predicted screen information from the server apparatus 100 during a period from after the display of the screen to the detection of the next input operation.

In addition, upon detecting the next input operation, the terminal apparatus 200 transmits the operation information indicating the detected input operation to the server apparatus 100. On this occasion, the terminal apparatus 200 displays, on the display, a screen based on the predicted screen data associated with the input operation when the operation information indicating the detected input operation is included in any of the predicted screen information which has been preliminarily received.

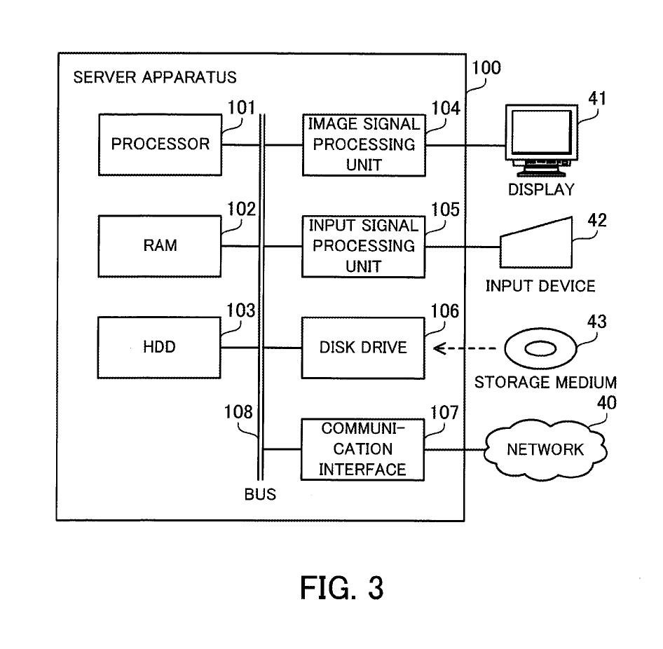

FIG. 3 illustrates an exemplary hardware configuration of a server apparatus. The server apparatus 100 has a processor 101, a RAM (Random Access Memory) 102, an HDD (Hard Disk Drive) 103, an image signal processing unit 104, an input signal processing unit 105, a disk drive 106, and a communication interface 107. These units are connected to a bus 108 in the server apparatus 100.

The processor 101 includes a calculator configured to execute instructions of a program. The processor 101 loads, to the RAM 102, at least a part of programs or data stored in the HDD 103, and executes the program. The processor 101 may include a plurality of processor cores. In addition, the server apparatus 100 may include a plurality of processors. In addition, the server apparatus 100 may perform parallel processing using a plurality of processors or a plurality of processor cores. In addition, a set of two or more processors, dedicated circuits such as an FPGA (Field Programmable Gate Array) or an ASIC (Application Specific Integrated Circuit), a set of two or more dedicated circuits, a combination of a processor and a dedicated circuit, or the like may be referred to as a “processor”.

The RAM 102 is a volatile memory configured to temporarily store a program executed by the processor 101 or data referred to from the program. The server apparatus 100 may include a memory of a type other than the RAM, or may include a plurality of volatile memories.

The HDD 103 is a nonvolatile storage device configured to store programs such as the OS (Operating System), firmware, and application programs, and data. The server apparatus 100 may include another type of storage device such as a flash memory, or may include a plurality of nonvolatile storage devices.

According to an instruction from the processor 101, the image signal processing unit 104 outputs an image to a display 41 connected to the server apparatus 100. A CRT (Cathode Ray Tube) display, a liquid crystal display or the like may be used as the display 41.

The input signal processing unit 105 obtains an input signal from an input device 42 connected to the server apparatus 100 and notifies the processor 101 of the input signal. A pointing device such as a mouse or a touch panel, a keyboard or the like may be used as the input device 42.

The disk drive 106 is a drive device configured to read programs or data stored in a storage medium 43. For example, a magnetic disk such as a Flexible Disk (FD) or an HDD, an optical disk such as a CD (Compact Disc) or DVD (Digital Versatile Disc), or a Magneto-Optical disk (MO) may be used as the storage medium 43. According to an instruction from the processor 101, the disk drive 106 stores programs or data read from the storage medium 43 in the RAM 102 or the HDD 103.

The communication interface 107 communicates with other information processing apparatuses (e.g., the terminal apparatus 200, etc.) via a network such as the network 40.

The server apparatus 100 need not include the disk drive 106 and, when being accessed exclusively from other information processing apparatuses, need not include the image signal processing unit 104 and the input signal processing unit 105. In addition, the display 41 and the input device 42 may be integrally formed with the housing of the server apparatus 100.

The terminal apparatus 200 may also be implemented using hardware similar to the server apparatus 100.

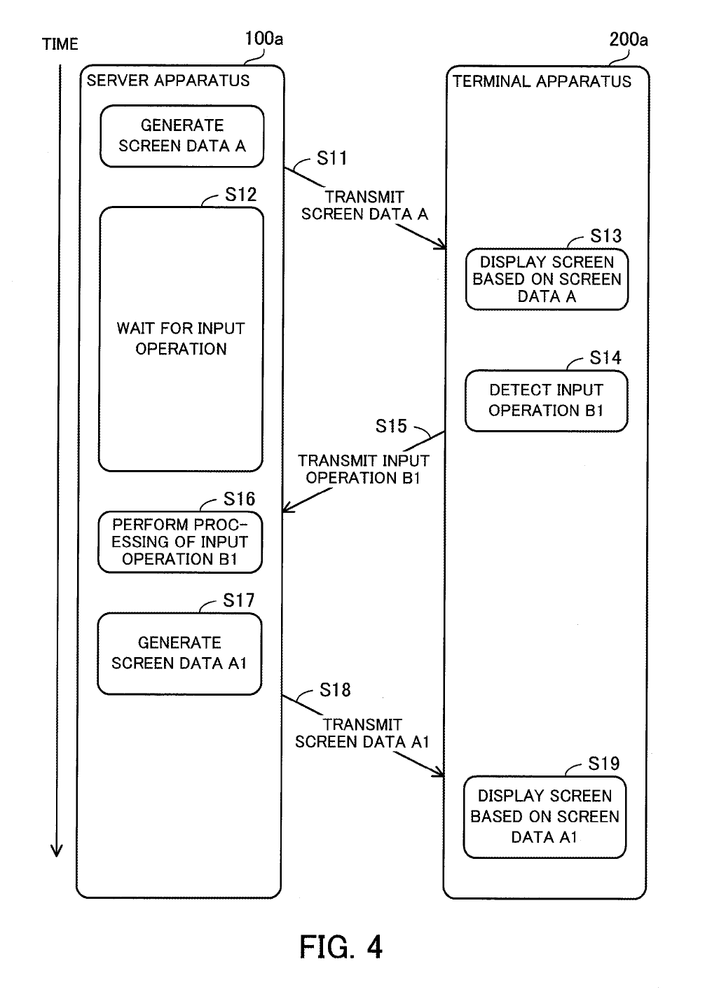

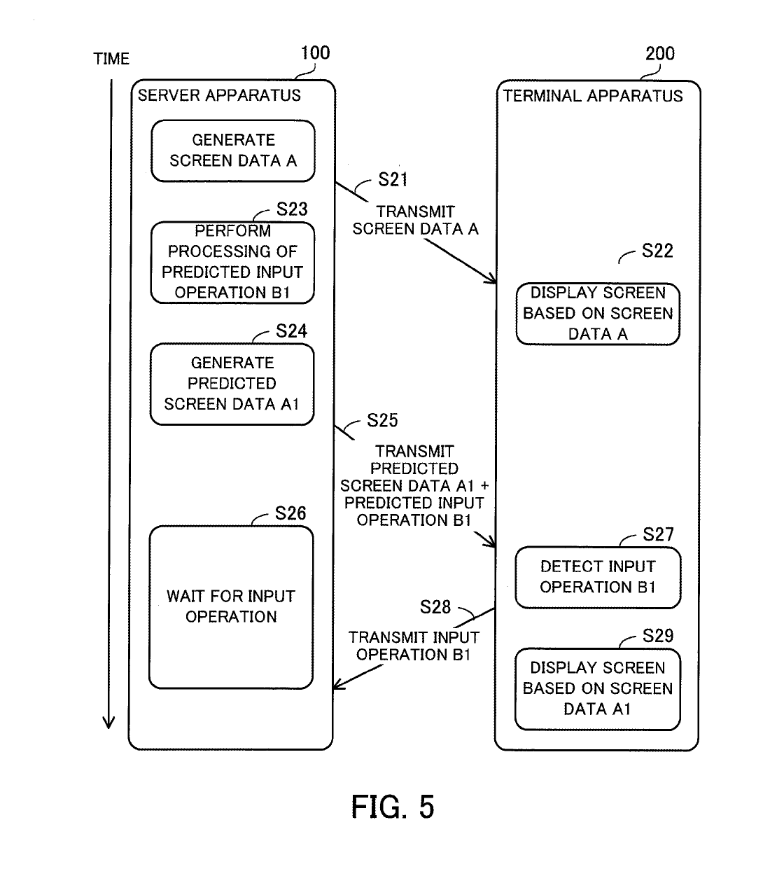

Next, the outline of display control by the display control system of the second embodiment will be described. First, a reference example of display control will be described referring to FIG. 4, followed by description of display control by the embodiment in which problems in the reference example are improved, referring to FIG. 5. FIGS. 4 to 5 illustrate a process of switching screen display of the terminal apparatus from a screen based on screen data A to a screen based on screen data A1, according to an input operation B1 detected by the terminal apparatus.

FIG. 4 illustrates a reference example of a process corresponding to an input operation when a speculative execution is not performed. In the following, the process illustrated in FIG. 4 will be described along with step numbers.

First, a server apparatus 100a generates screen data A and transmits it to a terminal apparatus 200a. The terminal apparatus 200a receives the screen data A (step S11).

Next, the server apparatus 100a enters an input operation wait state waiting for reception of operation information indicating an input operation from the terminal apparatus 200a (step S12). On the other hand, the terminal apparatus 200a displays, on the display, a screen based on the received screen data A (step S13).

Next, the terminal apparatus 200a detects the input operation B1 (step S14). The terminal apparatus 200a transmits the operation information indicating the detected input operation B1 to the server apparatus 100a. The server apparatus 100a receives the operation information indicating the input operation B1 (step S15).

Next, the server apparatus 100a executes the process corresponding to the received operation information, and transmits the screen data A1 generated by execution of the process to the terminal apparatus 200a. The terminal apparatus 200a receives the screen data A1 (step S18). The terminal apparatus 200a then displays, on the display, a screen based on the received screen data A1 (step S19).

FIG. 5 illustrates an exemplary process corresponding to an input operation when a speculative execution is performed. In the following the process illustrated in FIG. 5 will be described along with step numbers.

First, the server apparatus 100 generates the screen data A and transmits it to the terminal apparatus 200. The terminal apparatus 200 receives the screen data A (step S21). The terminal apparatus 200 displays, on the display, a screen based on the received screen data A (step S22).

On this occasion, the server apparatus 100 predicts the next input operation before receiving the operation information indicating the next input operation from the terminal apparatus 200, and executes a process corresponding to the predicted input operation B1 (step S23). Accordingly, predicted screen data A1 is generated by execution of the process (step S24). The server apparatus 100 then transmits, to the terminal apparatus 200, predicted screen information associating the generated predicted screen data A1 with the operation information indicating the predicted input operation B1. The terminal apparatus 200 receives the predicted screen information (step S25). The received predicted screen information is temporarily stored in a storage area included in the terminal apparatus 200. On this occasion, the server apparatus 100 enters an input operation wait state waiting for reception of operation information indicating an input operation from the terminal apparatus 200 (step S26).

The terminal apparatus 200 then detects the input operation B1 (step S27), and transmits the operation information indicating the detected input operation B1 to the server apparatus 100 (step S28). On this occasion, the terminal apparatus 200 determines whether or not the prediction of the next input operation by the server apparatus 100 is correct. In the example of FIG. 5, the predicted input operation B1 indicated by the predicted screen information received at step S25 matches the detected input operation B1 and therefore the prediction is determined to be correct. In this case, the terminal apparatus 200 displays, on the display, a screen based on the predicted screen data A1 corresponding to the predicted input operation B1 (step S29).

Here, in the process illustrated in FIG. 4, the processes of steps S15 to S19 take execution time during a period from the detection of the input operation B1 by the terminal apparatus 200a to the display of a screen based on the screen data A1. The execution time includes the time taken for the information transmission at step S15 and the time taken for the information transmission at step S18. The longer the distance of physical transmission path between the server apparatus 100a and the terminal apparatus 200a is, the longer the transmission time becomes. In the communication between Japan and Europe, for example, there may occur a transmission delay for about several hundred milliseconds in round-trip delay. As described above, there has been a problem that the further the terminal apparatus 200a is physically separated from the server apparatus 100a, the longer the response time from the input operation performed by a user to the display of the screen according to the input operation becomes, whereby the response performance deteriorates.

One method of improving the response performance is compressing the screen data to be transmitted to reduce the amount of data. However, transmission delay based on a communication distance is still not reduced by this method.

In contrast, the time from the detection of the input operation B1 by the terminal apparatus 200 to the display of a screen based on the screen data A1 in the process of the embodiment illustrated in FIG. 5 only takes the time for performing the process of step S29. In other words, time from the detection of an input operation to the display of a screen in the process illustrated in FIG. 5 is shortened in comparison with the process illustrated in FIG. 4 by the time from transmission of the operation information indicating the input operation B1 to reception of the screen data A1. The shortened time includes the time taken for transmitting the operation information and the time taken for transmitting the screen data A1.

As thus described, the server apparatus 100 in the display control system of the second embodiment predicts the next input operation and performs the process corresponding to the predicted input operation. In the following, the process performed by the server apparatus 100 corresponding to the predicted input operation may be referred to as a “speculative process”, and execution of a speculative process may be referred to as “speculative execution”.

The terminal apparatus 200 then preliminarily stores, before the next input operation, the operation information indicating the predicted input operation predicted by the server apparatus 100 in association with the predicted screen data generated by execution of a speculative process. Subsequently, the terminal apparatus 200, upon detecting the input operation indicated by the predicted input operation preliminarily stored therein, displays a screen based on the preliminarily stored predicted screen data on the display. Accordingly, the time from detection of the input operation to switching of the screen display is shortened when the prediction of the input operation is correct.

The server apparatus 100 performs a process according to the input operation actually detected by the terminal apparatus 200 and a process according to the predicted input operation (speculative process). Furthermore, the server apparatus 100 may predict a plurality of input operations which are different from each other and perform a speculative process according to each of the predicted input operations.

Therefore, in the embodiment, with a plurality of virtual machines being operated on the server apparatus 100, a process according to the actually detected input operation and each of the plurality of speculative processes respectively according to different ones of the predicted input operations are performed on separate virtual machines, respectively. In the following, each of the virtual machines may be referred to as an “execution virtual machine”.

Furthermore, in the present embodiment, the plurality of execution virtual machines is collectively controlled by another virtual machine. In the following, the virtual machine controlling the execution virtual machines may be referred to as a “control virtual machine”.

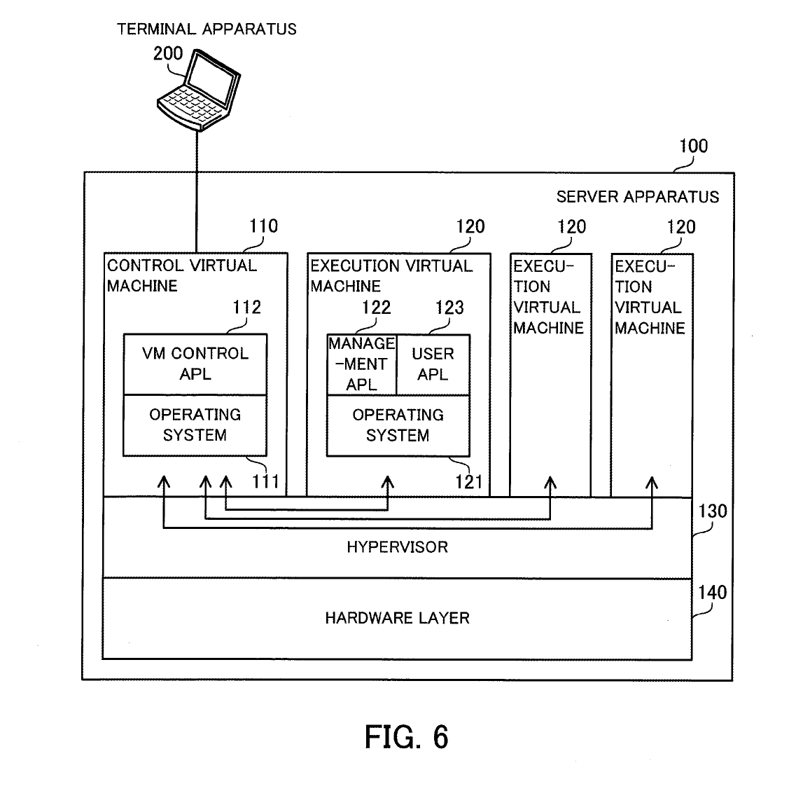

FIG. 6 is a block diagram illustrating an exemplary function of the server apparatus in terms of programs. The server apparatus 100 has a function of realizing virtualization of a computer. In the server apparatus 100, a control virtual machine 110 and a plurality of execution virtual machines 120 operate. In addition, the server apparatus 100 has a hypervisor 130 and a hardware layer 140.

The hardware layer 140 controls resources provided to the control virtual machine 110 and the plurality of execution virtual machines 120 such as calculation resources of the processor 101, and storage resources of the RAM 102. The processing in the hardware layer 140 may be realized, for example, by execution of a driver program for each resource by the processor 101 of the server apparatus 100.

The processing by the hypervisor 130 is realized, for example, by execution of a hypervisor program by the processor 101 of the server apparatus 100.

The hypervisor 130 implements and controls the control virtual machine 110 and the plurality of execution virtual machines 120. On this occasion, the hypervisor 130 allocates resources to the control virtual machine 110 and the plurality of execution virtual machines 120. In addition, the hypervisor 130 relays communication between the control virtual machine 110 and the execution virtual machines 120.

In addition, the hypervisor 130 has a function of copying the state of resource from one virtual machine to another. Accordingly, it is possible to change a resource state of one execution virtual machine 120 to be identical to a resource state of another execution virtual machine 120, for example. In the following, such a function may be referred to as “resource copying”.

In addition, a memory area assigned to each virtual machine, for example, may be a resource subject to resource copying. In this case, resource copying refers to copying the content of the memory area allocated to one virtual machine to a memory area allocated to another virtual machine.

The execution virtual machine 120 is a virtual machine configured to execute application programs in place of the terminal apparatus 200. The execution virtual machine 120 executes an application program to perform a process corresponding to an input operation detected by the terminal apparatus 200 or the predicted input operation predicted by the server apparatus 100, and generate image data of a screen including the execution result.

The execution virtual machine 120 takes either a normal state or a speculative state. The normal state is a state in which, upon receiving operation information from the terminal apparatus 200, the execution virtual machine 120 performs the process corresponding to the operation information. The speculative state is a state in which the execution virtual machine 120 performs a speculative process according to the predicted input operation.

Only one of the plurality of execution virtual machines 120 enters the normal state, whereas all the other ones enter the speculative state. Therefore, at least two execution virtual machines 120 are implemented on the server apparatus 100. The number of execution virtual machines 120 is determined by the number of predicted input operations. In the present embodiment, it is assumed that there are two predicted input operations, for example. In this case, three execution virtual machines 120 are implemented.

The execution virtual machine 120 has an operating system 121, a management APL (Application) 122, and a user APL 123.

The processing by the operating system 121 is implemented by executing a guest OS program on the execution virtual machine 120. The operating system 121 manages the resources logically allocated from the hypervisor 130, and schedules the execution of application programs.

The processing by the management APL 122 is implemented by executing a predetermined management application program on the execution virtual machine 120. The management APL 122 switches the state of the execution virtual machine 120 to which the management APL 122 belongs according to a request of the control virtual machine 110. Specifically, the management APL 122, upon receiving a change-of-state request from the control virtual machine 110, switches to the speculative state when the current state is the normal state, or switches to the normal state when the current state is the speculative state.

In the following description, the state of the execution virtual machine 120 to which each process block belongs may be simply referred to as a “state thereof”.

The management APL 122, when the state thereof is the normal state, receives, from the control virtual machine 110, the operation information indicating the input operation detected by the terminal apparatus 200 and causes the user APL 123 to perform the process corresponding to the received operation information. The management APL 122 then transmits the screen data output from the user APL 123 to the terminal apparatus 200 via the control virtual machine 110.

The management APL 122, on the other hand, when the state thereof is the speculative state, receives the operation information indicating the predicted input operation from the control virtual machine 110 and causes the user APL 123 to perform a process (speculative process) corresponding to the received operation information. The management APL 122 then generates predicted screen information including the screen data output from the user APL 123 and the operation information indicating the corresponding predicted input operation, and transmits the predicted screen information to the terminal apparatus 200 via the control virtual machine 110.

The execution virtual machine 120 may transmit the screen data or the predicted screen information directly to the terminal apparatus 200 without via the control virtual machine 110.

The processing by the user APL 123 is implemented by executing an application program available to the user on the execution virtual machine 120. The user APL 123 receives operation information indicating an input operation from the control virtual machine 110 and performs the process corresponding to the received operation information. In addition, the user APL 123 transmits the screen data generated by execution of the process to the terminal apparatus 200 via the control virtual machine 110.

Here, when the execution virtual machine 120 is in the speculative state, predicted operation information is transmitted from the control virtual machine 110 to the user APL 123. In this case, the user APL 123 performs a speculative process according to the predicted operation information.

The control virtual machine 110 is a virtual machine configured to control the plurality of execution virtual machines 120. The control virtual machine 110 has an operating system 111 and a VM (Virtual Machine) control APL 112. The operating system 111 has a function similar to the operating system 121.

The processing by the VM control APL 112 is implemented by executing a predetermined VM control application program on the control virtual machine 110.

The VM control APL 112 predicts the next input operation detected by the terminal apparatus 200. The number of predicted input operations may be one, or two or more. The number of predicted input operations is assumed to be two in the present embodiment. In addition, the VM control APL 112 causes each of the execution virtual machines 120 being in the speculative state to perform speculative execution of the processes corresponding to the predicted input operations which are different from each other.

In addition, the VM control APL 112 receives, from the terminal apparatus 200, the operation information indicating the input operation detected by the terminal apparatus 200. The VM control APL 112 determines whether or not the prediction is correct by determining whether or not there exists an execution virtual machine 120 which has already performed speculative execution of the process corresponding to the received operation information.

When there exists an execution virtual machine 120 which has performed speculative execution of the process corresponding to the received operation information, the VM control APL 112 first requests an execution virtual machine 120 being in the normal state and the execution virtual machine 120 having performed the speculative execution to change the state of virtual machines.

When there is no execution virtual machine 120 having performed speculative execution of the process corresponding to the received operation information, the VM control APL 112 causes an execution virtual machine 120 being in the normal state to perform the process corresponding to the received operation information.

In addition, the VM control APL 112 requests each execution virtual machine 120 being in the speculative state to copy a resource from the execution virtual machine 120 whose state has been changed to the normal state.

In addition, the VM control APL 112 relays transmission of screen data or predicted screen information from the execution virtual machine 120 to the terminal apparatus 200.

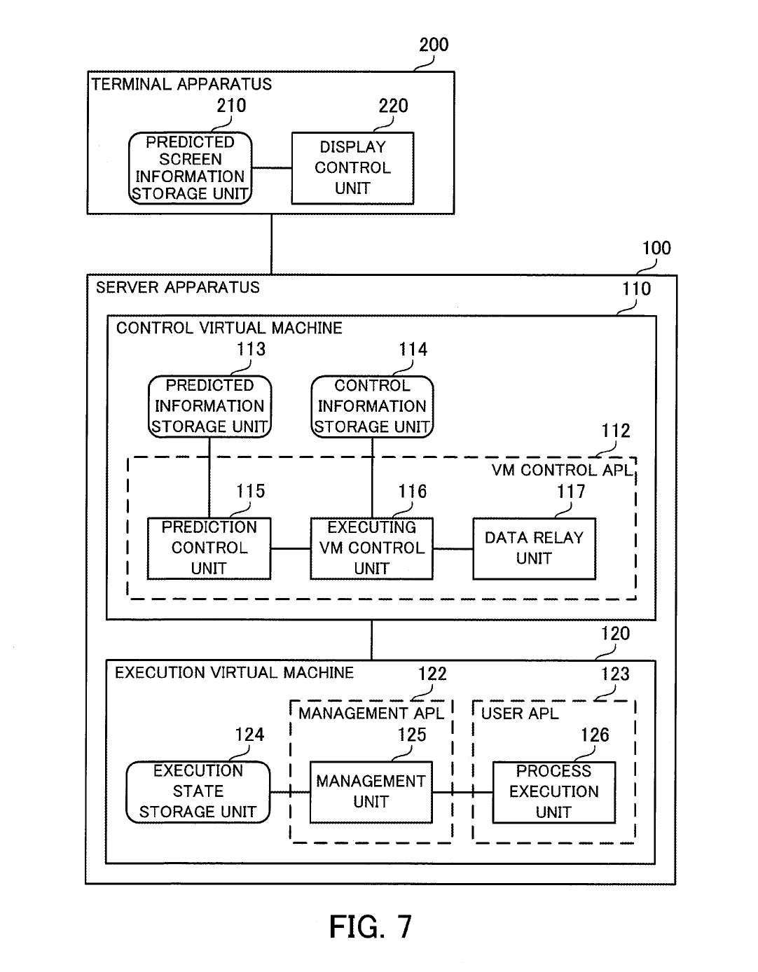

FIG. 7 illustrates exemplary functions of the server apparatus and the terminal apparatus. The control virtual machine 110 has the VM control APL 112, a predicted information storage unit 113, and a control information storage unit 114. The VM control APL 112 has a prediction control unit 115, an executing VM control unit 116, and a data relay unit 117.

The predicted information storage unit 113 and the control information storage unit 114 may be implemented as a storage area secured in the RAM 102 or the HDD 103 included in the server apparatus 100. The prediction control unit 115, the data relay unit 117, and the executing VM control unit 116 may be implemented as program modules to be executed by the processor 101 included in the server apparatus 100.

The predicted information storage unit 113 stores a prediction management table. The prediction management table is a table storing information relating to the frequency of a process corresponding to an input operation detected for each ID of the screen displayed on the desktop. In addition, the predicted information storage unit 113 may store screen transition information associating operation information indicating an input operation on a certain screen with the ID of the screen to be displayed next according to the input operation.

The control information storage unit 114 stores an executing VM management table storing information for managing each execution virtual machine 120. The executing VM management table includes the information indicating the state of each execution virtual machine 120, the operation information indicating the input operation notified to the execution virtual machine 120 being in the normal state, the operation information indicating the predicted input operation notified to each execution virtual machine 120 being in the speculative state, and the like.

According to a request from the executing VM control unit 116, the prediction control unit 115 predicts the next input operation, based on the screen ID corresponding to the screen being displayed on the terminal apparatus 200, the frequency information stored in the prediction management table, and the like. The screen ID (i.e., the screen ID corresponding to the screen data last generated by the execution virtual machine 120 being in the normal state) corresponding to the screen being displayed has been registered in the executing VM management table. In addition, the prediction control unit 115 updates the executing VM management table with the predicted input operation.

The executing VM control unit 116 determines whether or not the prediction by the prediction control unit 115 is correct. Specifically, the executing VM control unit 116 refers to the executing VM management table and determines whether or not any of the execution virtual machines 120 has already performed speculative execution of the process corresponding to the operation information received by the data relay unit 117 from the terminal apparatus 200.

When one of the execution virtual machines 120 has already performed speculative execution, the executing VM control unit 116 first requests to change the state of the execution virtual machine 120 which has already performed speculative execution to the normal state, and change the state of the execution virtual machine 120 being in the normal state to the speculative state.

In addition, when any of the execution virtual machines 120 has not yet performed speculative execution, in other words, when all the predictions of input operations are wrong, the executing VM control unit 116 transmits the received operation information to the execution virtual machine 120 being in the normal state.

In addition, the executing VM control unit 116 requests each execution virtual machine 120 being in the speculative state to copy a resource from the execution virtual machine 120 whose state has been changed to the normal state.

Furthermore, the executing VM control unit 116 transmits each piece of operation information indicating the predicted input operation predicted by the prediction control unit 115 to each execution virtual machine 120 being in the speculative state. On this occasion, the executing VM control unit 116 transmits, to the execution virtual machines 120, operation information indicating predicted input operations which are different from each other.

The executing VM control unit 116 receives the screen data from the execution virtual machine 120 being in the normal state, and transmits the received screen data to the terminal apparatus 200 via the data relay unit 117. On this occasion, the executing VM control unit 116 registers the screen ID corresponding to the received screen data in the executing VM management table.

In addition, the executing VM control unit 116 receives the predicted screen information from the execution virtual machine 120 being in the speculative state, and transmits the received predicted screen information to the terminal apparatus 200 via the data relay unit 117. On this occasion, the executing VM control unit 116 registers, in the executing VM management table, the predicted screen data included in the received predicted screen information and the operation information indicating the predicted input operation.

The data relay unit 117 receives operation information indicating an input operation from the terminal apparatus 200. In addition, the data relay unit 117 transfers the screen data or the predicted screen information received by the executing VM control unit 116 to the terminal apparatus 200. When transferring the screen data or the predicted screen information to the terminal apparatus 200, the data relay unit 117 transfers it after compressing the predicted screen information according to a predetermined compression method.

Here, the amount of the screen data and the predicted screen data included in the predicted screen information is large and therefore communication between the data relay unit 117 and the terminal apparatus 200 may take time. Therefore, transferring with the data being compressed reduces the amount of communication data between the data relay unit 117 and the terminal apparatus 200, whereby the time taken for communication between the data relay unit 117 and the terminal apparatus 200 is shortened.

The compression methods include the JPEG (Joint Photographic Experts Group) method, the GIF (Graphics Interchange Format) method, the PNG (Portable Network Graphics) method and the like, and the data relay unit 117 may support any of the compression methods. In addition, for example, such a compression method may be used as transmitting only the image data corresponding to the difference between the screen being displayed and the screen to be displayed next.

The execution virtual machine 120 has the management APL 122, the user APL 123, and an execution state storage unit 124. The management APL 122 has a management unit 125, and the user APL 123 has a process execution unit 126. The execution state storage unit 124 may be implemented as a storage area secured in the RAM 102 or the HDD 103 included in the server apparatus 100. The management unit 125 and the process execution unit 126 may be implemented as program modules to be executed by the processor 101 included in the server apparatus 100.

The execution state storage unit 124 stores information indicating the state of the execution virtual machine 120. The state is either the normal state or the speculative state. There is only one execution virtual machine 120 being in the normal state, with the other execution virtual machines 120 being in the speculative state.

The management unit 125 receives operation information indicating an input operation or operation information indicating a predicted input operation from the control virtual machine 110. The management unit 125 causes the process execution unit 126 to perform the process corresponding to the received operation information, and obtains screen data generated as a result of the process, from the process execution unit 126.

In addition, the management unit 125, when the state thereof is the normal state, transmits the screen data generated by the process execution unit 126 to the terminal apparatus 200 via the control virtual machine 110. The management unit 125, when the state thereof is the speculative state, transmits the predicted screen information associating the screen data generated by the process execution unit 126 with the operation information indicating the predicted input operation to the terminal apparatus 200 via the control virtual machine 110.

In addition, according to the resource copy request from the control virtual machine 110, the management unit 125 uses the hypervisor 130 to copy a resource from the execution virtual machine 120 being in the normal state to a virtual machine belonging to the management unit 125.

The process execution unit 126 generates screen data by performing the process corresponding to the operation information received by the management unit 125.

The terminal apparatus 200 has a predicted screen information storage unit 210 and a display control unit 220. The predicted screen information storage unit 210 may be implemented as a storage area secured in the RAM or HDD included in the terminal apparatus 200. The display control unit 220 may be implemented as a program module to be executed by the processor included in the terminal apparatus 200.

The predicted screen information storage unit 210 stores a predicted screen information table. The predicted screen information table is a table temporarily storing predicted screen information received from the server apparatus 100.

The display control unit 220 receives one or more pieces of predicted screen information from the server apparatus 100. The predicted screen information is compressed according to a predetermined compression method. The display control unit 220 decompresses the compressed predicted screen information and updates the predicted screen information table with the decompressed predicted screen information.

In addition, the display control unit 220 detects an input operation by the user and transmits operation information indicating the detected input operation to the server apparatus 100. In addition, the display control unit 220 determines whether or not operation information indicating a predicted input operation that matches the detected input operation is included in the predicted screen information table.

When operation information indicating a matching predicted input operation is included, the display control unit 220 displays, on the display, a screen based on the predicted screen data corresponding to the matching predicted input operation.

When no operation information indicating a matching predicted input operation is included, the display control unit 220 receives, from the server apparatus 100, screen data corresponding to the transmitted input operation. The received screen data has been compressed according to a predetermined compression method. The display control unit 220 decompresses the compressed screen data and displays a screen based on the decompressed screen data, on the display.

The predicted screen information storage unit 210 is an example of the storage unit 21. In addition, the display control unit 220 is an example of the control unit 22.

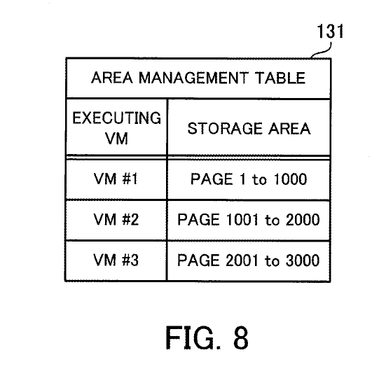

Next, a table used by the display control system will be described, referring to FIGS. 8 to 11.

FIG. 8 illustrates an exemplary area management table. An area management table 131 is a table storing a piece of information for managing resources allocated to each virtual machine, the information relating to the storage area used by each virtual machine. The area management table 131 is stored in a storage area such as the RAM 102. The storage-area-related information stored in the area management table 131 is managed by the hypervisor 130. The area management table 131 has fields for the executing VM and storage area.

The executing VM field has set therein an identifier for identifying the execution virtual machine 120. The storage area field has stored therein information indicating the storage area used by the execution virtual machine 120. The value set in the storage area may be in units of pages such as “page 1 to 1000”, for example, or may be set in terms of addresses.

The storage area used by the execution virtual machine 120 includes, for example, an area for storing data when executing an application program, an area for storing a program when a virtual machine executes an application program, and the like. Furthermore, the storage area includes an area for storing data when a virtual machine executes the operating system, an area for storing a program when an execution virtual machine executes the operating system, and the like.

When resource copying is requested from any of the execution virtual machines 120, the hypervisor 130 may determine from which real memory area allocated to the copy source execution virtual machine 120 to which real memory area allocated to the copy destination execution virtual machine 120 the content is to be copied, by referring to the area management table 131.

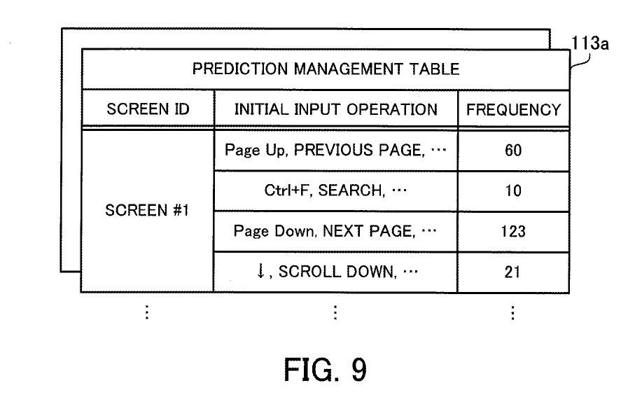

FIG. 9 illustrates an exemplary prediction management table. A prediction management table 113a is a table storing information relating to the frequency of an input operation detected for each type of screen displayed on the desktop. The prediction management table 113a is stored in the predicted information storage unit 113 for each of the application programs performed on the desktop. The application programs mentioned here are programs that implement the processing by the user APL 123. The prediction management table 113a for each of the application programs is further stored for each of the users using the application programs.

The prediction management table 113a has fields for the screen ID, initial input operation, and frequency.

The screen ID field has set therein a screen ID generated by executing an application program for identifying the type of screen displayed on the terminal apparatus 200. The screen identified by the screen ID is a screen having one or more predetermined elements respectively arranged at a given position. The elements may be, for example, an operation component, a process result display area, and the like.

An operation component is an area for accepting a pointing operation by a mouse click or the like. In other words, performing a pointing operation on an area of a certain operation component on the screen triggers the process corresponding to the operation component.

In addition, the same process is triggered for at least some of the operation components by a predetermined key operation in place of an operation on the operation component. In other words, a screen identified by a screen ID has acceptable key operations preliminarily associated therewith.

A process result according to the last detected input operation is displayed on the process result display area. For example, when an input operation is performed during execution of an application program (i.e., during processing of the process execution unit 126 of the user APL 123), one of the screen IDs is selected and an element corresponding to the selected screen ID is arranged and drawn at a predetermined position, and also the process result is drawn in the process result display area. Accordingly, screen data of the screen to be displayed on the terminal apparatus 200 is generated.

For example, the types of screen identified by the screen ID include the main screen and various setting screens. When there exists a plurality of types of setting screens, individual screen IDs are provided to respective setting screens.

In the case of a document display program, for example, the main screen is displayed by activation of the program. The main screen has arranged thereon operation components for scrolling, scaling, or various settings of a document displayed thereon. In addition, the main screen includes a process result display area in which a document is displayed.

Subsequent to performing a pointing operation to an operation component on the main screen or a predetermined key operation, there is a case where only the display on the process result display area on the main screen changes, or a case where a different type of screen such as a setting screen is displayed. In the former case, the screen ID of the screen being displayed does not change also after the input operation. In the latter case, on the other hand, a screen with a different screen ID is displayed after the input operation.

The initial input operation field in the prediction management table 113a has set therein operation information indicating an input operation allowed for a user to perform on a corresponding type of screen. In other words, the field of initial input operation has set therein operation information indicating a key operation associated with a screen as described above, or an operation to an operation component. In addition, a plurality of pieces of operation information may be set in a single record corresponding to the initial input operation field. In this case, it is suggested that the same process is performed when input operations respectively indicated by the plurality of pieces of operation information are performed.

For example, there are an operation of pressing the “F” key while pressing the “Ctrl” key (denoted as “Ctrl+F”), and a pointing operation to the “search” operation component as an input operation to trigger a search process in the example of FIG. 9. Therefore, the operation information indicating the input operation corresponding to the search process is like “Ctrl+F, search, etc.”

Actually, key identification information such as a key code is set in the case of a key operation, whereas coordinate information indicating the display area of the operation component is set in the case of an operation component, as the operation information to be set in the initial input operation field. The same goes for the operation information transmitted and received between the server apparatus 100 and the terminal apparatus 200.

The frequency field in the prediction management table 113a has set therein a value indicating the frequency of detecting the corresponding input operation, with the corresponding type of screen being displayed. The number of times input operations are detected, or the ratio of the number of detection times of the corresponding input operation to the total number of detection times of input operations while the same type of screen is being displayed is set as the value indicating the frequency. The information indicating the frequency is referred to when the prediction control unit 115 predicts the next input operation.

The setting value of the initial input operation field in the prediction management table 113a may be extracted by executing a predetermined program for analyzing a target application program, for example. Alternatively, the setting value of an input operation may be registered each time the server apparatus 100 receives operation information indicating a new input operation from the terminal apparatus 200. In the latter case, only the operation information indicating the input operation actually detected by the terminal apparatus 200 is registered in the prediction management table 113a for each screen ID.

In addition, the prediction management table may have a value set therein indicating the frequency for each combination of a detected input operation and an input operation detected next, for example, while the same type of screen is being displayed. Performing prediction using such information improves the precision of prediction.

Additionally, in order to reduce the load of setting the frequency or prediction processing, or in order to reduce the amount of data stored in the server apparatus 100, for example, the prediction management table may have set therein the operation information corresponding to only one type of screen such as the main screen and information indicating the frequency.

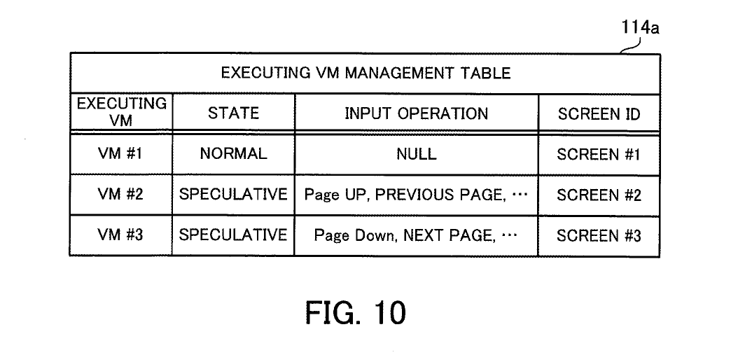

FIG. 10 illustrates an exemplary executing VM management table. An executing VM management table 114a is a table storing information for managing each of the execution virtual machines 120. The executing VM management table 114a is stored in the control information storage unit 114. The executing VM management table 114a has fields for the executing VM, state, input operation, and screen ID.

The executing VM field has set therein an identifier for identifying the execution virtual machine 120.

The state field has set therein information indicating the state of the execution virtual machine 120. For example, the state field having “normal” set therein indicates that the execution virtual machine 120 is in the normal state. The state field having “speculative” set therein indicates that the execution virtual machine 120 is in the speculative state.

The input operation field has set therein operation information corresponding to a speculative process performed by the execution virtual machine 120. The operation information corresponding to the speculative process includes operation information indicating one or more input operations, similarly to the initial input operation field of the prediction management table 113a (see FIG. 9). In addition, when the execution virtual machine 120 is in the normal state, speculative execution is not performed and therefore “NULL” is set to the input operation field, for example.

The screen ID field has stored therein a screen ID indicating the type of the screen last generated by the execution virtual machine 120. For example, “screen #1” indicates that it is a screen of the screen ID “#1”.

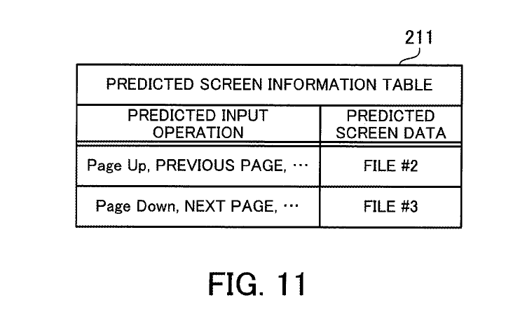

FIG. 11 illustrates an exemplary predicted screen information table. A predicted screen information table 211 is a table temporarily storing predicted screen information received from the server apparatus 100. The predicted screen information table 211 is stored in the predicted screen information storage unit 210. The predicted screen information table 211 has fields of the predicted input operation and predicted screen data.

The predicted input operation field has set therein operation information indicating the next input operation predicted by the server apparatus 100, i.e., operation information corresponding to the process speculatively performed by the execution virtual machine 120. The operation information corresponding to the speculatively performed process includes operation information indicating one or more input operations, similarly to the initial input operation field of the prediction management table 113a (see FIG. 9).

The predicted screen data field has set therein the file name of the predicted screen data generated by the execution virtual machine 120 being in the speculative state. The predicted screen data is generated by performing a speculative process by the execution virtual machine 120 being in the speculative state.

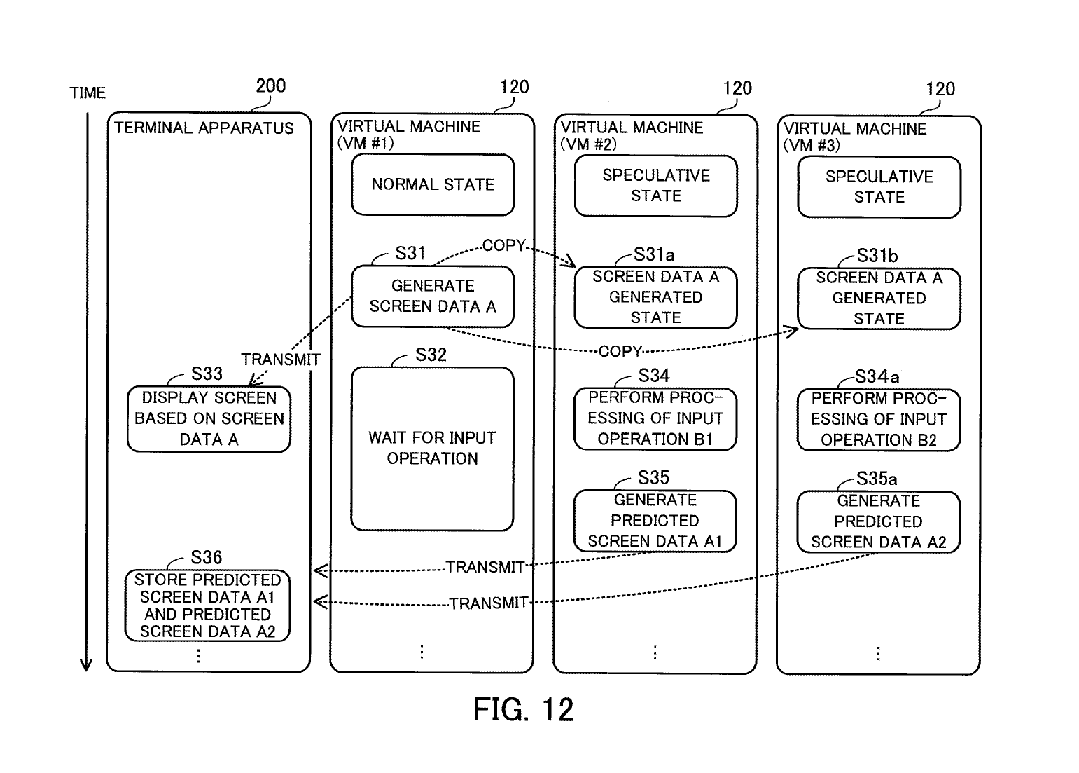

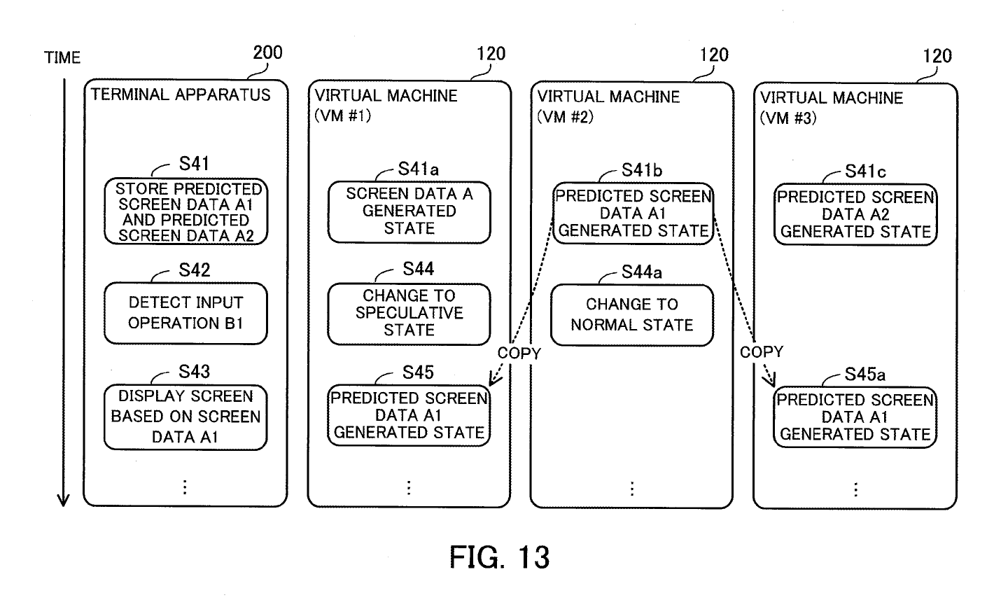

Next, display control by the execution virtual machine 120 will be described, referring to FIGS. 12 to 13. It is assumed in the description for FIGS. 12 to 13 that generation of the initial screen of the application program available to the user is performed by the execution virtual machine 120 being in the normal state (similarly, in the following). It is also assumed in the description for FIGS. 12 to 13 that the execution virtual machines 120 are provided with identifiers VM#1, VM#2 and VM#3. In the following, the execution virtual machine 120 with the identifier VM#1 may be denoted as “execution virtual machine (VM#1)”. In addition, explanation of processing of the control virtual machine 110 is omitted in the description for FIGS. 12 to 13.

FIG. 12 illustrates an exemplary process immediately after activation of an application program. It is assumed that the execution virtual machine (VM#1) is in the normal state, and the execution virtual machine (VM#2) and the execution virtual machine (VM#3) are in the speculative state. In the following, the process illustrated in FIG. 12 will be described along with step numbers.

The execution virtual machine (VM#1) being in the normal state generates the screen data A of the initial screen (step S31). In this state, the resource state is copied from the execution virtual machine (VM#1) being in the normal state to the execution virtual machine (VM#2) and the execution virtual machine (VM#3). For example, the content of the storage area of the execution virtual machine (VM#1) is copied to respective storage areas of the execution virtual machine (VM#2) and the execution virtual machine (VM#3). Accordingly, both the execution virtual machine (VM#2) and the execution virtual machine (VM#3) enter a state in which the screen data A has been generated, similarly to the execution virtual machine (VM#1) (steps S31a, S31b).

In addition, the execution virtual machine (VM#1) enters the input operation waiting state after transmission of the generated screen data A to the terminal apparatus 200 (step S32). The terminal apparatus 200 then displays a screen based on the received screen data A (step S33), on the display.

Each of the execution virtual machines 120 being in the speculative state receives operation information indicating a predicted input operation from the control virtual machine 110, and performs the process corresponding to the received operation information. Here, it is assumed that the execution virtual machine (VM#2) has performed the process corresponding to the predicted input operation B1 (step S34) and the execution virtual machine (VM#3) has performed a process corresponding to a predicted input operation B2 (step S34a).

The execution virtual machine (VM#2) then enters a state in which the predicted screen data A1 has been generated by execution of the process corresponding to the predicted input operation B1 (step S35). Similarly, the execution virtual machine (VM#3) enters a state in which the predicted screen data A2 has been generated by execution of the process corresponding to the predicted input operation B2 (step S35a).

Each of the execution virtual machines 120 being in the speculative state then transmits the predicted screen data which has been generated to the terminal apparatus 200. As a result, the terminal apparatus 200 enters a state with the predicted screen data A1 and A2 stored therein (step S36).

FIG. 13 illustrates an exemplary process after an input operation on the terminal apparatus. As has been described in FIG. 12, the terminal apparatus 200 is in a state with the predicted screen data A1 and A2 stored therein (step S41), and the execution virtual machine (VM#1) is in a state with the screen data A generated therein (step S41a). In addition, the execution virtual machine (VM#2) is in a state with the predicted screen data A1 generated therein (step S41b) and the execution virtual machine (VM#3) is in a state with the predicted screen data A2 generated therein (step S41c).

In the above state, it is assumed that the terminal apparatus 200 has detected the input operation B1 (step S42). In this case, the predicted input operation B1 performed by the execution virtual machine (VM#2) matches the detected input operation B1 and therefore the terminal apparatus 200 displays, on the display, a screen based on the predicted screen data A1 corresponding to the predicted input operation B1 (step S43).

Next, the state of the execution virtual machine (VM#1) is changed to the speculative state (step S44), and the state of the execution virtual machine (VM#2) is changed to the normal state (step S44a).

The resource state is then copied from the execution virtual machine (VM#2) whose state has been changed to the normal state to each of the execution virtual machines 120 being in the speculative state. As a result, the execution virtual machine (VM#1) and the execution virtual machine (VM#3) enter a state with the screen data A1 generated therein, similarly to the execution virtual machine (VM#2) (steps S45 and S45a).

As has been described in FIGS. 12 to 13, causing a plurality of execution virtual machines 120 being in the speculative state to perform a plurality of speculative processes in parallel allows a plurality of speculative processes to be performed at a higher speed. In addition, copying the resource state from an execution virtual machine 120 being in the normal state to an execution virtual machine 120 being in the speculative state allows an environment for performing a speculative process to be easily generated.

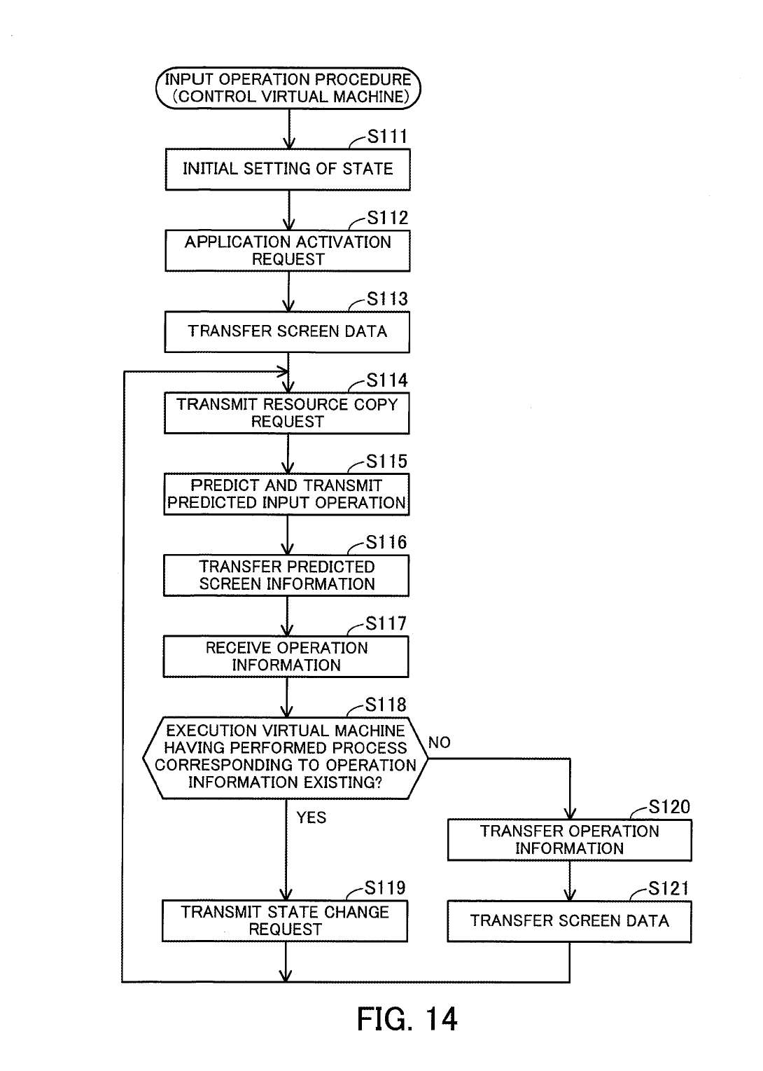

Next, a procedure of processes corresponding to an input operation will be described, referring to FIGS. 14 to 17.

FIG. 14 is a flow chart illustrating an exemplary process corresponding to an input operation on a control virtual machine. In the following, the processes illustrated in FIG. 14 will be described along with step numbers.

(Step S111) The executing VM control unit 116 performs initial setting of the state of respective execution virtual machines 120. Specifically, the executing VM control unit 116 requests to set one of the execution virtual machines 120 to the normal state and set the other execution virtual machines 120 to the speculative state.

In addition, the executing VM control unit 116 retrieves, from the executing VM management table 114a, a record with the identifier of the execution virtual machine 120 requested to be set to the normal state and registers “normal” in the state field of the retrieved record. In addition, the executing VM control unit 116 retrieves, from the executing VM management table 114a, a record with the identifier of each of the execution virtual machines 120 requested to be set to the speculative state and registers “speculative” in the state field of each of the retrieved records.

(Step S112) The data relay unit 117 receives, from the terminal apparatus 200, an activation request of an application program corresponding to the user APL 123. The executing VM control unit 116 transfers the received application activation request to the execution virtual machine 120 being in the normal state.

(Step S113) The executing VM control unit 116 receives the screen data of the initial screen from the execution virtual machine 120 being in the normal state. Next, the executing VM control unit 116 updates the executing VM management table 114a with the screen ID corresponding to the received screen data. Specifically, the executing VM control unit 116 retrieves a record whose state field is “normal” from the executing VM management table 114a, and updates the value of the screen data field of the retrieved record with the screen ID corresponding to the received screen data.

The data relay unit 117 then compresses the received screen data according to a predetermined compression method and transfers the compressed screen data to the terminal apparatus 200.

(Step S114) The executing VM control unit 116 transmits a resource copy request to each of the execution virtual machines 120 being in the speculative state. The resource copy request includes the identifier of the execution virtual machine 120 being in the normal state and serving as the copy source. The identifier of the execution virtual machine 120 being in the normal state is obtained by searching a record whose state field is set to “normal” from the executing VM management table 114a, and reading the identifier of the execution virtual machine 120 from the retrieved record. The executing VM control unit 116 then waits until a copy completion notification is received from all the execution virtual machines 120 being in the speculative state.

(Step S115) The prediction control unit 115 predicts an input operation as follows.

First, the prediction control unit 115 obtains a screen ID corresponding to the screen data generated by the execution virtual machine 120. Specifically, a record whose state field is “normal” is retrieved from the executing VM management table 114a, and the screen ID is obtained from the retrieved record. Next, the prediction control unit 115 retrieves, from the prediction management table 113a, a record having the obtained screen ID set thereto. Next, the prediction control unit 115 selects two records in descending order of frequency from the retrieved records, and predicts an input operation stored in each of the selected records as a predicted input operation.

Next, the prediction control unit 115 updates the frequency of each of the predicted input operations in the prediction management table 113a. Specifically, the prediction control unit 115 retrieves, from the prediction management table 113a, a record having each of two predicted input operations set thereto, and increments the value of the frequency of each of the retrieved records.

The executing VM control unit 116 then transmits pieces of operation information indicating the two predicted input operations, one by one, to each of the execution virtual machines 120 being in the speculative state. On this occasion, different operation information may be transmitted to each of the execution virtual machines 120.

The prediction control unit 115 may predict, as a predicted input operation, an input operation of each record for which the ratio of each frequency to the sum of the frequencies of all the input operations being equal to or higher than a threshold, for example. In this case, for example, there may be only one input operation predicted. In such a case, the prediction control unit 115 transmits operation information indicating the predicted input operation to only one of the execution virtual machines 120 being in the speculative state and causes the execution virtual machine 120 to perform a speculative process. On the other hand, for example, the number of execution virtual machines 120 being in the speculative state may be allowed to be dynamically changed. In this case, the prediction control unit 115 controls the execution virtual machines 120 so that the number of the execution virtual machines 120 being in the speculative state is equal to the number of predicted input operations.

(Step S116) The executing VM control unit 116 receives predicted screen information from each of the execution virtual machines 120 being in the speculative state.

Next, the executing VM control unit 116 retrieves, from the executing VM management table 114a, a record having set thereto the identifier of the transmission source execution virtual machine 120 of the predicted screen information. Next, the executing VM control unit 116 updates the value of the input operation field of the retrieved record with the operation information indicating the predicted input operation. The operation information indicating the predicted input operation is included in the received predicted screen information. In addition, the executing VM control unit 116 updates the screen ID field of the retrieved record with the screen ID corresponding to the predicted screen data included in the predicted screen information.

The data relay unit 117 then compresses the received predicted screen information according to a predetermined compression method and transfers the compressed screen information to the terminal apparatus 200.

(Step S117) The data relay unit 117 receives the operation information indicating the detected input operation from the terminal apparatus 200.

(Step S118) The executing VM control unit 116 determines whether or not the prediction at step S115 is correct. Specifically, the executing VM control unit 116 determines whether or not the record including the received operation information is retrieved from the executing VM management table 114a. In other words, the data relay unit 117 determines whether or not the execution virtual machine 120 which has performed the process corresponding to the received operation information is retrieved.

When the execution virtual machine 120 is retrieved, in other words, when prediction of any of the input operations is correct, the process flow proceeds to step S119. When the execution virtual machine 120 is not retrieved, in other words, prediction of all the input operations is wrong, the process flow proceeds to step S120.

(Step S119) The executing VM control unit 116 transmits a state change request to the execution virtual machine 120 being in the normal state. Accordingly, the state of the execution virtual machine 120 being in the normal state is changed to the speculative state. In addition, the executing VM control unit 116 retrieves a record whose state field is set to “normal” from the executing VM management table 114a, and updates the state field of the retrieved record to “speculative”.

In addition, the executing VM control unit 116 transmits a state change request to the execution virtual machine 120 which has performed speculative execution of the process corresponding to the received operation information detected at step S117. Accordingly, the state of the retrieved execution virtual machine 120 is changed to the normal state. In addition, the executing VM control unit 116 updates the state field to “normal” in the record with the identifier of the execution virtual machine 120 to which the state change request has been transmitted, and updates the input operation field to “NULL”.

(Step S120) The executing VM control unit 116 transfers the operation information received at step S117 to the execution virtual machine 120 being in the normal state.

(Step S121) The executing VM control unit 116 receives the screen data from the execution virtual machine 120 being in the normal state.

Next, the executing VM control unit 116 updates the executing VM management table 114a with the screen ID corresponding to the received screen data as follows. First, the executing VM control unit 116 retrieves a record whose state field is “normal” from the executing VM management table 114a, and updates the screen ID field of the retrieved record to the screen ID corresponding to the received screen data.

The data relay unit 117 then compresses the received screen data according to a predetermined compression method, and transfers the compressed screen data to the terminal apparatus 200. The process flow then proceeds to step S114.

At steps S113, S116 and S121, the executing VM control unit 116 determines the screen ID corresponding to the screen data received from the execution virtual machine 120. The determination method may be one of those described in the following.

With one method, the execution virtual machine 120 notifies the executing VM control unit 116 of the screen ID corresponding to the generated screen data. With another method, the executing VM control unit 116 itself determines the screen ID corresponding to the screen data generated by the execution virtual machine 120.

With the latter method, a correspondence table is stored in the control information storage unit 114 of the control virtual machine 110, for example, the correspondence table including operation information associated with a screen identified by a certain screen ID and a screen ID of a screen displayed next when the input operation indicated by the operation information is performed. Referring to the correspondence table, the executing VM control unit 116 may determine the screen ID corresponding to the screen data generated next, from the screen ID corresponding to the screen data last transmitted to the terminal apparatus 200 and the operation information indicating the input operation detected by the terminal apparatus 200 or the input operation predicted by the prediction control unit 115.

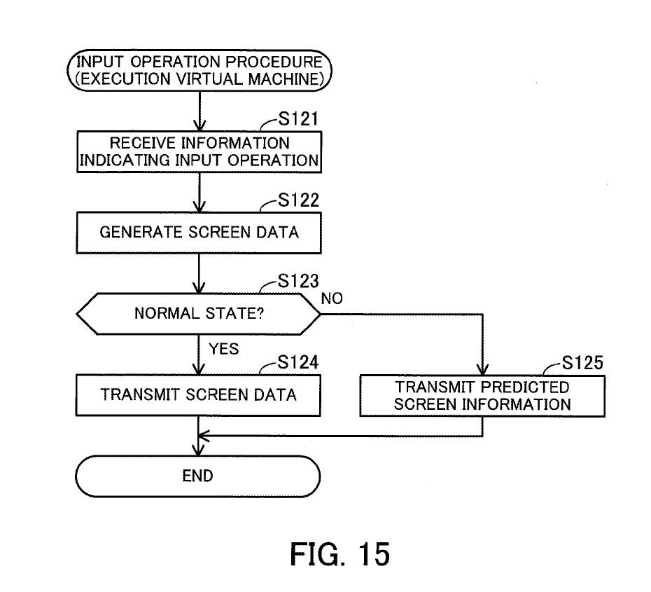

FIG. 15 is a flow chart illustrating an exemplary procedure corresponding to an input operation on an execution virtual machine. In the following, the procedure illustrated in FIG. 15 will be described along with step numbers.

(Step S121) The management unit 125 receives operation information indicating an input operation from the control virtual machine 110. The operation information received may indicate an input operation detected by the terminal apparatus 200, or may indicate a predicted input operation predicted by the control virtual machine 110.

(Step S122) The process execution unit 126 performs the process corresponding to the received operation information. As a result, screen data to be displayed on the display of the terminal apparatus 200 is generated.

(Step S123) The management unit 125 determines whether or not the state thereof is in the normal state. The information indicating the state thereof is determined by referring to the execution state storage unit 124. When the state thereof is the normal state, the process flow proceeds to step S124. When the state thereof is the speculative state, the process flow proceeds to step S125.

(Step S124) The management unit 125 transmits the generated screen data to the terminal apparatus 200 via the control virtual machine 110.

(Step S125) The management unit 125 transmits, via the control virtual machine 110, information including the generated screen data and the received operation information (i.e., operation information indicating the predicted input operation) to the terminal apparatus 200 as the predicted screen information.

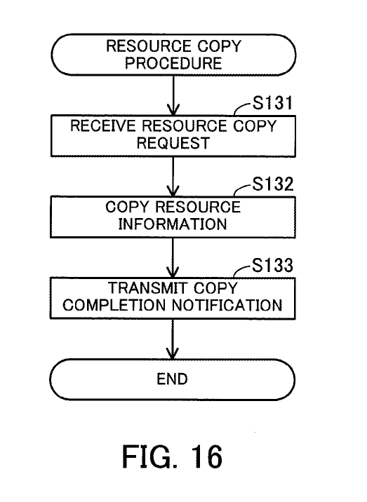

FIG. 16 is a flow chart illustrating an exemplary resource copy procedure. In the following, the procedure illustrated in FIG. 16 will be described along with step numbers.

(Step S131) The management unit 125 receives a resource copy request from the control virtual machine 110. The resource copy request includes an identifier of the execution virtual machine 120 being in the normal state and serving as the copy source.

(Step S132) The management unit 125 requests the hypervisor 130 to copy a resource of the execution virtual machine 120 being in the normal state. The identifier of the execution virtual machine 120 being in the normal state is obtained according to the resource copy request received at step S131. The hypervisor 130 then performs the resource copying as follows.

First, the hypervisor 130 retrieves a record having set thereto the identifier of the execution virtual machine 120 being in the normal state from the area management table 131, and reads information indicating a storage area from the retrieved record. Next, the hypervisor 130 retrieves, from the area management table 131, a record having set thereto the identifier of execution virtual machine 120 that has requested copying, and reads information indicating a storage area from the retrieved record. The hypervisor 130 then overwrites the storage area of the copy destination which has been read as image data with the content stored in the copy source storage area which has been read. The hypervisor 130 then notifies the execution virtual machine 120 of completion of copying.

The hypervisor 130 may extract, from the storage areas of the copy source and the copy destination which have been read, a storage area having no matching data, and copy only the data in the extracted storage area. In addition, the management unit 125 may copy only the difference between the data, or may specify to the hypervisor 130 whether or not to copy data of the entire storage area.

(Step S133) After completion of resource copying (after receiving a notification from the hypervisor 130 that the copying has been completed), the management unit 125 transmits a copy completion notification to the control virtual machine 110.

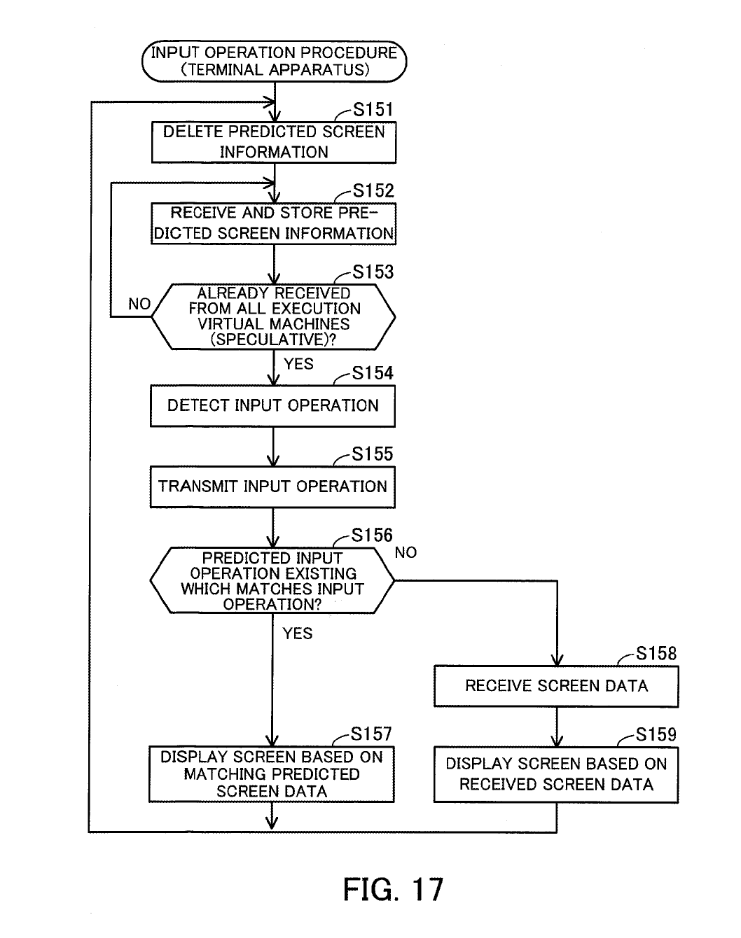

FIG. 17 is a flow chart illustrating an exemplary process corresponding to an input operation on the terminal apparatus. It is assumed that the initial state of the process illustrated in FIG. 17 is a state displaying a screen based on the screen data received from the server apparatus 100 after activating an application program available to the user. In the following, the procedure illustrated in FIG. 17 will be described along with step numbers.

(Step S151) The display control unit 220 deletes all the records in a predicted screen information table 211. When activating an application program, the predicted screen information table 211 is initialized into a state with all the records deleted.

(Step S152) The display control unit 220 receives, from the server apparatus 100, predicted screen information generated by one of the execution virtual machines 120 being in the speculative state. The received predicted screen information has been compressed at step S116 of FIG. 14. The display control unit 220 decompresses the received predicted screen information.

The display control unit 220 then registers the decompressed predicted screen information in the predicted screen information table 211. In the registered record, the predicted input operation field has set therein the operation information indicating the predicted input operation included in the decompressed predicted screen information. Similarly, the predicted screen data field has set therein the predicted screen data included in the decompressed predicted screen information.

(Step S153) The display control unit 220 determines whether or not the predicted screen information generated by all the execution virtual machines 120 being in the speculative state has already been received. When the predicted screen information has already been received from all the execution virtual machines 120, the process flow proceeds to step S154. When there exists an execution virtual machine 120 which has not received the predicted screen information, the process flow proceeds to step S152. At step S153, it suffices to determine whether or not a predetermined number of pieces of predicted screen information have already been received, for example.

When activating an application program available to the user, processes of steps S152 and S153 are skipped.

(Step S154) The display control unit 220 detects an input operation by the user. For example, the input operation may be a pointing operation to a predetermined operation component by pressing a key or clicking on the mouse.

(Step S155) The display control unit 220 transmits the operation information indicating the detected input operation to the server apparatus 100.

(Step S156) The display control unit 220 determines whether or not there exists a predicted input operation that matches the detected input operation in the predicted screen information table 211. Specifically, the display control unit 220 determines whether or not a record including the operation information indicating the detected input operation is retrieved from the predicted screen information table 211.

When there exists a predicted input operation that matches the detected input operation, the process flow proceeds to step S157. When there is no predicted input operation that matches the detected input operation, the process flow proceeds to step S158.

(Step S157) The display control unit 220 reads screen data corresponding to the matching predicted input operation from the predicted screen information table 211. Specifically, the display control unit 220 reads the predicted screen data set in the record retrieved at step S156.

The display control unit 220 then displays a screen based on the predicted screen data which has been read, on the display.

(Step S158) The display control unit 220 receives, from the server apparatus 100, screen data corresponding to the input operation transmitted at step S155. The received screen data has been compressed at step S121 of FIG. 14. The display control unit 220 decompresses the received screen data.

(Step S159) The display control unit 220 displays a screen based on the received and decompressed screen data, on the display.

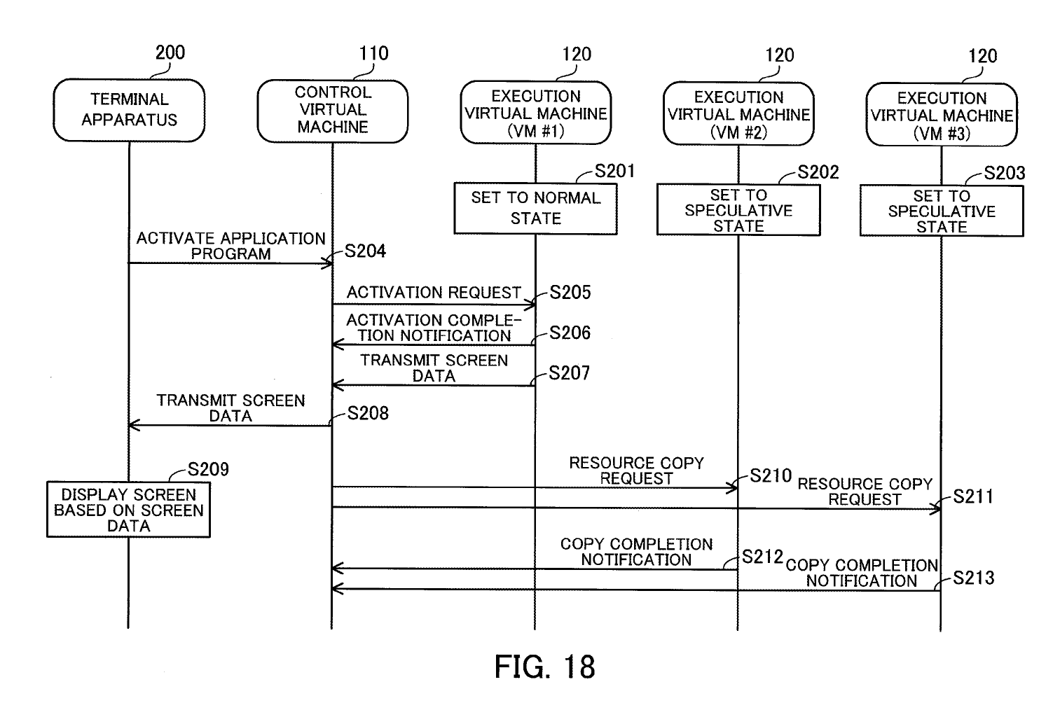

Next, an exemplary sequence when an application program available to the user is activated and an input operation is performed will be described, referring to FIGS. 18 to 21. In the description for FIGS. 18 to 21, it is assumed that the server apparatus 100 is operating one control virtual machine 110 and three execution virtual machines 120. In addition, it is assumed that the execution virtual machines 120 are provided with identifiers VM#1, VM#2 and VM#3. In the following, the execution virtual machine 120 with the identifier VM#1 may be denoted as “execution virtual machine (VM#1)”, and the same goes for the execution virtual machines 120 with other identifiers such as “VM2#”.

In addition, description of the compression and decompression processing of image data and predicted screen information is omitted in the description referring to FIGS. 18 to 21.

FIG. 18 illustrates an exemplary sequence of processes corresponding to an input operation. In the following, the procedure illustrated in FIGS. 18 to 21 will be described along with step numbers.

The execution virtual machine (VM#1) is set to the normal state (Step S201), the execution virtual machine (VM#2) and the execution virtual machine (VM#3) are set to the speculative state (Steps S202 and S203).

In the above state, upon being instructed to activate an application program, the terminal apparatus 200 transmits, to the control virtual machine 110, a notification that activation of the application program has been instructed. The control virtual machine 110 receives the notification that activation of the application program has been instructed (Step S204). Next, the control virtual machine 110 transmits, to the execution virtual machine (VM#1) being in the normal state, an activation request including information indicating the application program to be activated. The execution virtual machine (VM#1) receives the activation request from the control virtual machine 110 (Step S205). Next, the execution virtual machine (VM#1) activates the application program included in the activation request and, upon completion of the activation, transmits an activation completion notification to the control virtual machine 110. The control virtual machine 110 receives the activation completion notification from the execution virtual machine (VM#1) (Step S206). Next, the execution virtual machine (VM#1) transmits, to the control virtual machine 110, the screen data generated when activating the application program, together with the activation completion notification. The control virtual machine 110 receives the screen data from the execution virtual machine (VM#1) (Step S207). Next, the control virtual machine 110 transfers the received screen data to the terminal apparatus 200. The terminal apparatus 200 receives the screen data from the control virtual machine 110 (Step S208). The terminal apparatus 200 then displays a screen based on the received screen data, on the display (Step S209).

Next, the control virtual machine 110 transmits a resource copy request to the execution virtual machine (VM#2) being in the speculative state. The execution virtual machine (VM#2) receives the resource copy request from the control virtual machine 110 (Step S210). Similarly, the control virtual machine 110 transmits a resource copy request to the execution virtual machine (VM#3) being in the speculative state. The execution virtual machine (VM#3) receives the resource copy request from the control virtual machine 110 (Step S211).

The execution virtual machine (VM#2) and the execution virtual machine (VM#3) request the hypervisor 130 to copy a resource from the execution virtual machine (VM#1). Accordingly, the resource states (for example, storage area) of the execution virtual machine (VM#2) and the execution virtual machine (VM#3) become identical to the resource state of the execution virtual machine (VM#1).

Next, upon completion of the resource copying, the execution virtual machine (VM#2) transmits a copy completion notification to the control virtual machine 110. The control virtual machine 110 receives the copy completion notification from the execution virtual machine (VM#2) (Step S212). Similarly, upon completion of the resource copying, the execution virtual machine (VM#3) transmits a copy completion notification to the control virtual machine 110. The control virtual machine 110 receives the copy completion notification from the execution virtual machine (VM#3) (Step S213).

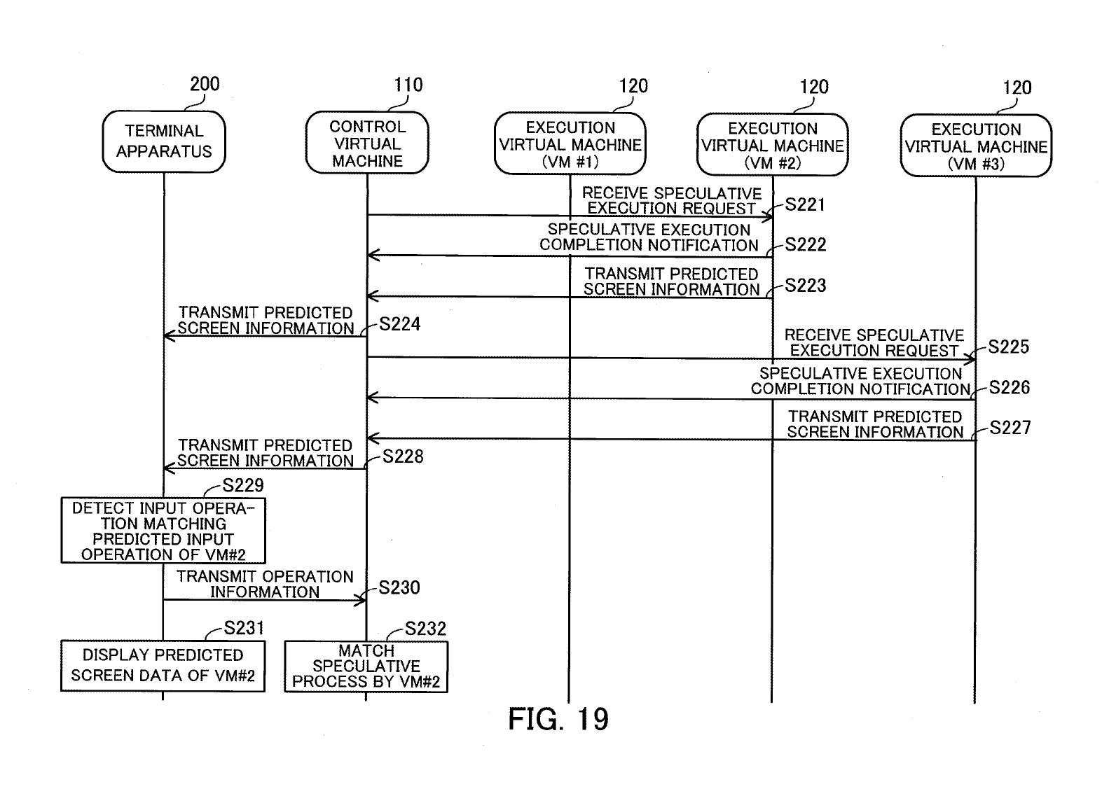

FIG. 19 illustrates an exemplary sequence of processes corresponding to the input operation (sequence 1).

Next, the control virtual machine 110 predicts input operations to be detected by the terminal apparatus 200 next, and transmits a speculative execution request to the execution virtual machine (VM#2) being in the speculative state, together with operation information indicating one of the predicted input operations. The execution virtual machine (VM#2) receives the speculative execution request from the control virtual machine 110 (Step S221). Next, the execution virtual machine (VM#2) performs a speculative procedure corresponding to the predicted input operation and, upon completion of the execution of the speculative process, transmits a speculative execution completion notification to the control virtual machine 110. The control virtual machine 110 receives the speculative execution completion notification from the execution virtual machine (VM#2) (Step S222). Next, the execution virtual machine (VM#2) transmits, to the control virtual machine 110, the predicted screen data generated by execution of the speculative process and the predicted screen information including the operation information indicating the predicted input operation. The control virtual machine 110 receives the predicted screen information from the execution virtual machine (VM#2) (Step S223). The control virtual machine 110 transfers the received predicted screen information to the terminal apparatus 200. The terminal apparatus 200 receives predicted screen information from the control virtual machine 110 (Step S224).

Similarly, the control virtual machine 110 transmits a speculative execution request to the execution virtual machine (VM#3) being in the speculative state, together with operation information indicating another predicted input operation. The execution virtual machine (VM#3) receives the speculative execution request from the control virtual machine 110 (Step S225). The execution virtual machine (VM#3) performs a speculative process corresponding to the predicted input operation and, upon completion of the speculative process, transmits a speculative execution completion notification to the control virtual machine 110. The control virtual machine 110 receives the speculative execution completion notification from the execution virtual machine (VM#3) (Step S226). Next, the execution virtual machine (VM#3) transmits, to the control virtual machine 110, the predicted screen information associating the predicted screen data generated by execution of the speculative process and the operation information indicating the predicted input operation. The control virtual machine 110 receives the predicted screen information from the execution virtual machine (VM#3) (Step S227). The control virtual machine 110 transfers the received predicted screen information to the terminal apparatus 200. The terminal apparatus 200 receives the predicted screen information from the control virtual machine 110 (Step S228).

The terminal apparatus 200 detects an input operation from the user, and assumes that the detected input operation matches the predicted input operation corresponding to the speculative process executed by the execution virtual machine (VM#2) (Step S229). The terminal apparatus 200 transmits the operation information indicating the detected input operation to the control virtual machine 110. The control virtual machine 110 receives operation information indicating the input operation from the terminal apparatus 200 (Step S230).

On this occasion, it is assumed that the predicted input operation included in the predicted screen information transmitted by the execution virtual machine (VM#2) matches the detected input operation. In this case, the terminal apparatus 200 displays, on the display, a screen based on the predicted screen data included in the predicted screen information transmitted by the execution virtual machine (VM#2) (Step S231). In addition, the control virtual machine 110 determines that the process corresponding to the received input operation matches the speculative process performed by the execution virtual machine (VM#2) (Step S232). The order of performing the processes of steps S230 and S231 may be interchanged.

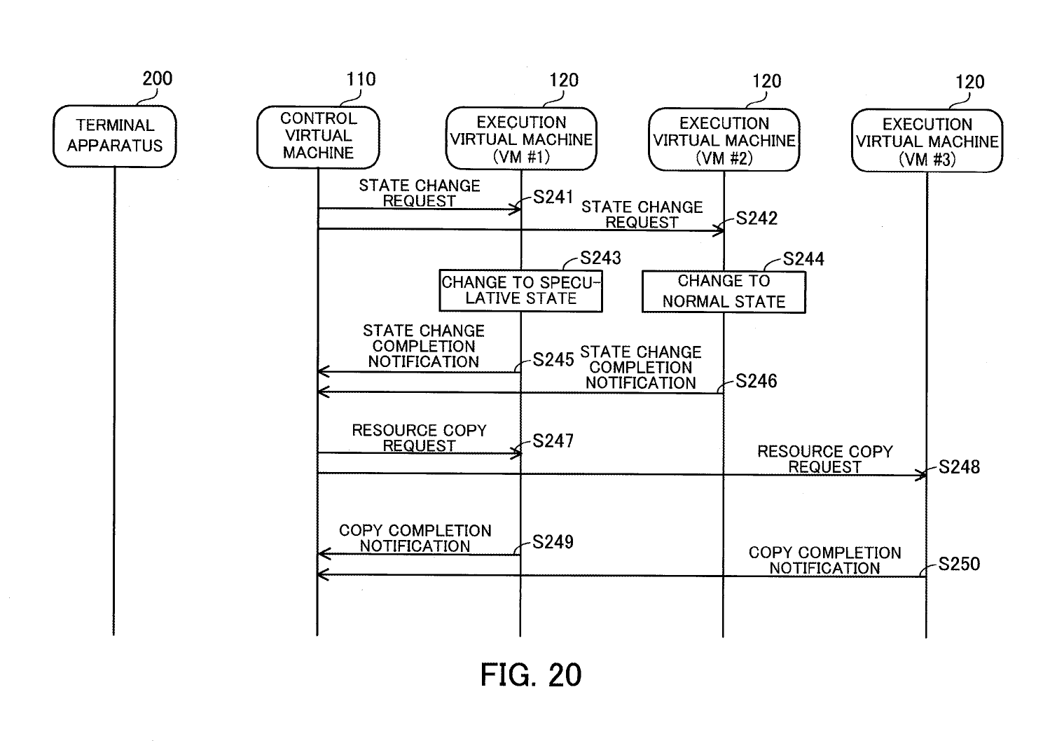

FIG. 20 illustrates an exemplary sequence of processes corresponding to the input operation (sequence 2).

The control virtual machine 110 transmits a state change request to the execution virtual machine (VM#1) being in the normal state. The execution virtual machine (VM#1) receives the state change request from the control virtual machine 110 (Step S241). Similarly, the control virtual machine 110 transmits a state change request to the execution virtual machine (VM#2) which has performed the process corresponding to the operation information received at step S230. The execution virtual machine (VM#2) receives the state change request from the control virtual machine 110 (Step S242). Next, the execution virtual machine (VM#1) changes the state from the normal state to the speculative state (Step S243). Similarly, the execution virtual machine (VM#2) changes the state from the speculative state to the normal state (Step S244). Next, the execution virtual machine (VM#1) transmits a state change completion notification to the control virtual machine 110. The control virtual machine 110 receives the state change completion notification from the execution virtual machine (VM#1) (Step S245). Next, the execution virtual machine (VM#2) transmits a state change completion notification to the control virtual machine 110. The control virtual machine 110 receives the state change completion notification from the execution virtual machine (VM#2) (Step S246).

Next, the control virtual machine 110 transmits a resource copy request to the execution virtual machine (VM#1) being in the speculative state. The execution virtual machine (VM#1) receives the resource copy request from the control virtual machine 110 (Step S247). Similarly, the control virtual machine 110 transmits a resource copy request to the execution virtual machine (VM#3) being in the speculative state. The execution virtual machine (VM#3) receives the resource copy request from the control virtual machine 110 (Step S248).

The execution virtual machine (VM#1) and the execution virtual machine (VM#3) request the hypervisor 130 to copy a resource from the execution virtual machine (VM#2). Accordingly, the resource states of the execution virtual machine (VM#1) and the execution virtual machine (VM#3) become identical to the resource state of the execution virtual machine (VM#2).

Next, upon completion of the resource copying, the execution virtual machine (VM#1) transmits a copy completion notification to the control virtual machine 110. The control virtual machine 110 receives the copy completion notification from the execution virtual machine (VM#1) (Step S249). Similarly, upon completion of the resource copying, the execution virtual machine (VM#3) transmits a copy completion notification to the control virtual machine 110. The control virtual machine 110 receives the copy completion notification from the execution virtual machine (VM#3) (Step S250).

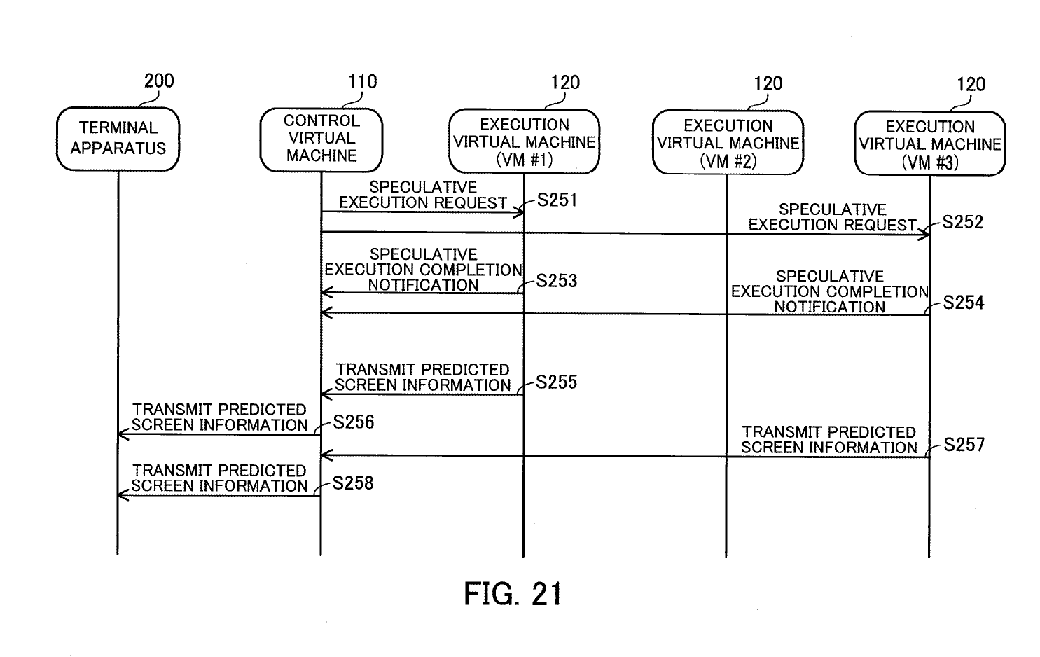

FIG. 21 illustrates an exemplary sequence of processes corresponding to the input operation (sequence 3).

Next, the control virtual machine 110 predicts input operations to be detected by the terminal apparatus 200, and transmits a speculative execution request to the execution virtual machine (VM#1) being in the speculative state, together with operation information indicating one of the predicted input operations. The execution virtual machine (VM#1) receives the speculative execution request from the control virtual machine 110 (Step S251). Similarly, the control virtual machine 110 transmits a speculative execution request to the execution virtual machine (VM#3) being in the speculative state, together with operation information indicating another predicted input operation. The execution virtual machine (VM#3) receives the speculative execution request from the control virtual machine 110 (Step S252).

Next, upon completion of the execution of the speculative process, the execution virtual machine (VM#1) transmits a speculative execution completion notification to the control virtual machine 110. The control virtual machine 110 receives the speculative execution completion notification from the execution virtual machine (VM#1) (Step S253). Similarly, upon completion of the execution of the speculative process, the execution virtual machine (VM#3) transmits a speculative execution completion notification to the control virtual machine 110. The control virtual machine 110 receives the speculative execution completion notification from the execution virtual machine (VM#3) (Step S254).

Next, the execution virtual machine (VM#1) transmits, to the control virtual machine 110, predicted screen information including the predicted screen data generated by execution of the speculative process and the operation information indicating the predicted input operation. The control virtual machine 110 receives the predicted screen information from the execution virtual machine (VM#1) (Step S255). The control virtual machine 110 transfers the received predicted screen information to the terminal apparatus 200. The terminal apparatus 200 receives the predicted screen information from the control virtual machine 110 (Step S256).

Similarly, the execution virtual machine (VM#3) transmits, to the control virtual machine 110, predicted screen information including the predicted screen data generated by execution of the speculative process and operation information indicating the predicted input operation. The control virtual machine 110 receives the predicted screen information from the execution virtual machine (VM#3) (Step S257). The control virtual machine 110 transfers the received predicted screen information to the terminal apparatus 200. The terminal apparatus 200 receives the predicted screen information from the control virtual machine 110 (Step S258).

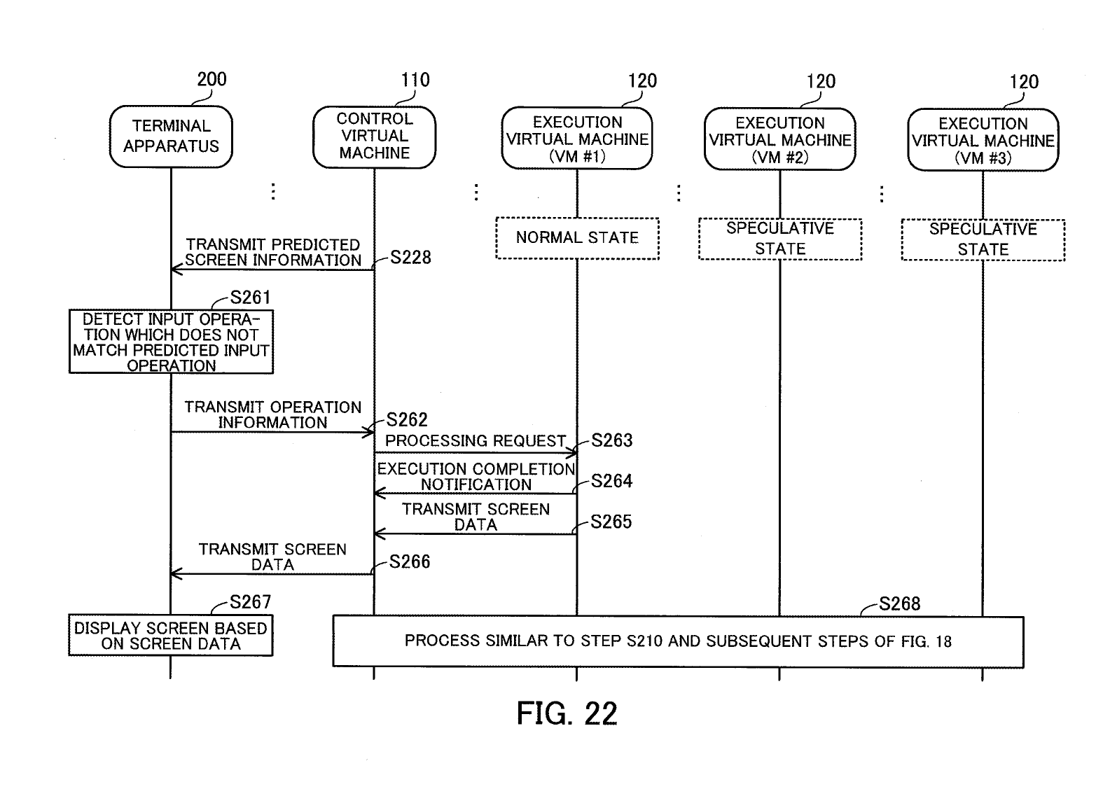

FIG. 22 illustrates an exemplary sequence of processes when the prediction of the input operation is not correct.

For example, at step S228 of FIG. 19, it is assumed that the predicted screen information which has been transmitted from the execution virtual machine (VM#2) and the execution virtual machine (VM#3), respectively, is transmitted to the terminal apparatus 200 from the control virtual machine 110. On this occasion, the execution virtual machine (VM#1) is in the normal state, whereas the execution virtual machine (VM#2) and the execution virtual machine (VM#3) are in the speculative state. Ii is assumed in this state that the terminal apparatus 200 detects an input operation from the user, but the detected input operation does not match any of the predicted input operations (Step S261).

The terminal apparatus 200 transmits the operation information indicating the detected input operation to the control virtual machine 110. The control virtual machine 110 receives operation information indicating an input operation from the terminal apparatus 200 (Step S262). On this occasion, the input operation indicated by the received operation information does not match any of the predicted input operations included in the predicted screen information transmitted from the execution virtual machine (VM#2) and the execution virtual machine (VM#3).

In this case, the control virtual machine 110 transmits the operation information received from the terminal apparatus 200 to the execution virtual machine (VM#1) being in the normal state, and requests processing thereof. The execution virtual machine (VM#1) receives the processing request and operation information from the control virtual machine 110 (Step S263). Next, the execution virtual machine (VM#1) performs the process corresponding to the input operation indicated by the received operation information and, upon completion of the execution, transmits an execution completion notification to the control virtual machine 110. The control virtual machine 110 receives the execution completion notification from the execution virtual machine (VM#1) (Step S264).

Next, the execution virtual machine (VM#1) transmits the screen data generated by execution of the process to the control virtual machine 110. The control virtual machine 110 receives the screen data from the execution virtual machine (VM#1) (Step S265). The control virtual machine 110 transfers the received screen data to the terminal apparatus 200. The terminal apparatus 200 receives the screen data from the control virtual machine 110 (Step S266). The terminal apparatus 200 then displays a screen based on received screen data, on the display (Step S267).

In addition, the control virtual machine 110 and the execution virtual machines 120 perform a process similar to step S210 and subsequent steps of FIG. 18 (Step S268). In other words, resource copying is performed to copy the resource state of the execution virtual machine (VM#1) being in the normal state to the execution virtual machine (VM#2) and the execution virtual machine (VM#3) being in the speculative state. After completion of the resource copying, the procedure corresponding to the predicted input operation predicted by the control virtual machine 110 and the generation process of the predicted screen information are performed by the execution virtual machine (VM#2) and the execution virtual machine (VM#3), respectively. The generated predicted screen information is transmitted to the terminal apparatus 200 via the control virtual machine 110.

According to the display control system of the second embodiment, the terminal apparatus 200 receives, before detecting the next input operation, the predicted screen information associating the predicted input operation and the predicted screen data from the server apparatus 100. When, upon detecting an input operation by the user, the detected input operation is included in the received predicted screen information, the terminal apparatus 200 displays a screen based on the received predicted screen data, on the display.

Displaying a screen based on the preliminarily stored predicted screen data thus becomes possible. Accordingly, the next screen data may be displayed with a probability according to the prediction precision without waiting for the time from transmission of information indicating input operation to the server apparatus 100 to reception of the screen data. Therefore, the delay from an input operation on the terminal apparatus 200 to the screen display may be suppressed. In particular, the delay between an input operation and the screen display may be shortened by the amount of transmission delay according to the distance between the apparatuses even when the terminal apparatus 200 is located at a position physically distant from the server apparatus 100, provided that the prediction of input operation is correct.

In addition, the server apparatus 100 predicts an input operation based on the frequency of the past input operations stored in the prediction management table 113a. Accordingly, input operation is predicted with a high precision and therefore the probability that the detected input operation matches the received predicted input operation increases. Therefore, the probability increases that the next screen data is allowed to be displayed without waiting for time from transmission of operation information indicating an input operation to the server apparatus 100 to reception of screen data.

In addition, the server apparatus 100 may cause a plurality of execution virtual machines 120 being in the speculative state to perform a plurality of speculative processes in parallel so that the time taken for performing a plurality of speculative processes may be shortened.

Furthermore, when the input operation detected by the terminal apparatus 200 matches the preliminarily stored predicted input operation, the server apparatus 100 changes the state of the execution virtual machine 120 which has performed the process corresponding to the detected input operation to the normal state, and copies the resource state from the execution virtual machine 120 whose state has been changed to the normal state to another execution virtual machine 120. Accordingly, the resource state for performing a speculative process may be easily generated, reducing the development cost thereby.

For example, there may be conceived a method which causes the aforementioned processes, which were being performed on each of the execution virtual machines 120, to be performed on the server apparatus 100 without using the virtual machines. However, there is a problem that such a method complicates the execution management process such as switching processes being performed, or the process of settling respective processes being performed in the same processing state (e.g., a state in which the same processes has been performed, or a state in which the content of the storage areas to be used are the same), which may lead to increased development cost or processing load. Such a problem may be solved by causing individual virtual machines to perform respective processes.

When transmitting the screen data corresponding to the detected input operation, the server apparatus 100 may extract data of the difference between the screen data corresponding to the detected input operation and the screen data before the detection, and transmit the extracted difference data to the terminal apparatus 200. In this case, the terminal apparatus 200 switches the displayed screen based on the received difference data and the screen data corresponding to the screen being displayed. The same goes for the predicted screen data.

Accordingly, the amount of communication of the screen data from the server apparatus 100 to the terminal apparatus 200 is suppressed, reducing the load of processing by the server apparatus 100 and the terminal apparatus 200 thereby. In addition, the time from detection of an input operation to switching of the screen display is shortened, even when the detected input operation does not match the preliminarily stored predicted input operation.

As has been described above, the information processing of the first embodiment may be realized by causing the information processing apparatus 10 and the terminal apparatus 20 to perform a program, and the information processing of the second embodiment may be realized by causing the server apparatus 100 and the terminal apparatus 200 to perform a program. Such a program may be stored in a computer-readable storage medium (e.g., the storage medium 43). The storage medium may be, for example, a magnetic disk, an optical disk, a magneto-optical disk, a semiconductor memory, or the like. The magnetic disk may be an FD or an HDD. The optical disk may be a CD, a CD-R (Recordable)/RW (Rewritable), a DVD, and a DVD-R/RW.

When distributing a program, for example, a portable storage medium is provided with the program stored therein. In addition, a program may be stored in a storage device of another computer, and the program may be distributed via a network. A computer stores, in a storage device thereof (e.g., the HDD 103), a program stored in a portable storage medium or received from another computer, for example, reads the program from the storage device, and executes the program. However, a program read from portable storage medium may be directly executed, or a program received from another computer via a network may be directly executed. In addition, at least a part of the aforementioned information processing may be realized by an electronic circuit such as a DSP (Digital Signal Processing), an ASIC, a PLD (Programmable Logic Device), or the like.

In one aspect, delay of screen display corresponding to an input operation on a terminal apparatus may be suppressed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A terminal apparatus which transmits operation information indicating a detected input operation to an information processing apparatus, receives screen data according to the input operation from the information processing apparatus, and displays, on a display device, a screen based on the received screen data, the terminal apparatus comprising:
a memory configured to temporarily store screen data; and
a processor configured to perform a procedure including:
receiving screen data according to a predicted next input operation from the information processing apparatus and storing the screen data in the memory, and
when, upon detecting a next input operation, the next input operation matches the predicted next input operation, displaying, on the display device, a screen based on the screen data stored in the memory.

2. The terminal apparatus according to claim 1, wherein the procedure further includes, upon detecting the next input operation, transmitting operation information indicating the next input operation to the information processing apparatus and, when the next input operation does not match the predicted next input operation, displaying, on the display device, a screen based on screen data transmitted from the information processing apparatus according to the transmitted operation information indicating the next input operation.

3. An information processing apparatus comprising:
a memory configured to store a plurality of pieces of operation information respectively indicating a plurality of input operations that are detected by a terminal apparatus; and
a processor configured to perform a procedure including:
performing a process corresponding to a first input operation detected by the terminal apparatus, generating first screen data indicating a screen according to execution of the process and transmitting the first screen data to the terminal apparatus, and also predicting a second input operation to be detected next by the terminal apparatus, based on the plurality of pieces of operation information, and
performing a process corresponding to the predicted second input operation, generating second screen data indicating a screen according to execution of the process and, before detection of a next input operation by the terminal apparatus, transmitting the second screen data to the terminal apparatus together with the operation information indicating the second input operation.

4. The information processing apparatus according to claim 3, wherein when, upon detection of the next input operation by the terminal apparatus after transmission of the second screen data to the terminal apparatus, the detected next input operation does not match the predicted second input operation, the procedure further includes
performing a process corresponding to the detected next input operation,
generating third screen data indicating a screen according to execution of the process, and
transmitting the third screen data to the terminal apparatus.

5. The information processing apparatus according to claim 3, wherein
the memory has stored therein information indicating a frequency of each of the plurality of input operations detected by the terminal apparatus, and
the predicting of the second input operation includes predicting the second input operation to be detected next by the terminal apparatus, based on the information indicating the frequency.

6. The information processing apparatus according to claim 3, wherein, upon detection of the first input operation by the terminal apparatus, a first procedure of performing a process corresponding to the first input operation and generating the first screen data and a second procedure of predicting the second input operation, performing a process corresponding to the predicted second input operation, and generating the second screen data are performed using a first virtual machine and a second virtual machine operating on the information processing apparatus, respectively.

7. The information processing apparatus according to claim 6, wherein the procedure further includes changing a resource state of the second virtual machine to be identical to a resource state of the first virtual machine having generated the first screen data, before execution of the process corresponding to the predicted second input operation using the second virtual machine.

8. The information processing apparatus according to claim 6, wherein when, upon detection of the next input operation by the terminal apparatus after transmission of the second screen data to the terminal apparatus, the detected next input operation matches the predicted second input operation, the procedure further includes
changing a resource state of the first virtual machine to be identical to a resource state of the second virtual machine,
then performing a process corresponding to a third input operation predicted to be detected next by the terminal apparatus and generation of third screen data indicating a screen according to execution of the process, using the first virtual machine, and
transmitting the generated third screen data to the terminal apparatus together with operation information indicating the third input operation.

9. The information processing apparatus according to claim 6, wherein when, upon detection of the next input operation by the terminal apparatus after transmission of the second screen data to the terminal apparatus, the detected input operation does not match the predicted second input operation, the procedure further includes
performing a process corresponding to the detected input operation and generation of screen data indicating a screen according to execution of the process, using the first virtual machine,
then changing a resource state of the second virtual machine to be identical to a resource state of the first virtual machine, and
performing a process corresponding to a third input operation to be predicted next by the terminal apparatus and generation of third screen data indicating a screen according to execution of the process, using the second virtual machine.

10. A display control method executed in a terminal apparatus for transmitting operation information indicating a detected input operation to an information processing apparatus, receiving screen data according to the input operation from the information processing apparatus, and displaying, on a display device, a screen based on the received screen data, the method comprising:
receiving screen data according to a predicted next input operation from the information processing apparatus and storing the screen data in a memory; and
when, upon detecting a next input operation, the next input operation matches the predicted next input operation, displaying, on the display device, a screen based on the screen data stored in the memory.

11. The display control method according to claim 10, further comprising:
upon detecting the next input operation, transmitting operation information indicating the next input operation to the information processing apparatus; and
when the next input operation does not match the predicted next input operation, displaying, on the display device, a screen based on the screen data transmitted from the information processing apparatus according to the transmitted operation information indicating the next input operation.
